(19) United States
(12) Patent Application Publication
(10) Pub. No.: US 2025/0153933 A1
(43) Pub. Date: May 15, 2025

(54) REFUSE LOADING SYSTEM WITH HORIZONTAL POSITIONING

(71) Applicant: The Heil Co., Chattanooga, TN (US)

(72) Inventors: Marc Nadeau, Levis (CA); Michel Fillion, Beaumont (CA); Phillip A. Kendrick, Chattanooga, TN (US); Michael Shane Peek, Pisgah, AL (US)

(21) Appl. No.: 18/941,401

(22) Filed: Nov. 8, 2024

Related U.S. Application Data
(60) Provisional application No. 63/598,015, filed on Nov. 10, 2023.

(51) Int. Cl. B65F 3/04

(52) U.S. Cl. CPC B65F 3/046

(57) ABSTRACT

A horizontal positioning system for a refuse loading system includes a base section, a distal section, one or more timing belt systems, one or more belt attachment devices, and one or more horizontal drive units. The base section is configured to couple to a frame of a refuse collection vehicle. The distal section is configured to couple between the base section and the refuse loading system and configured to translate with respect to the base section. At least a first one of the timing belt systems includes a pair of timing pulleys spaced horizontally from one another and each is rotatably coupled to the base section, and a timing belt is coupled around the pair of timing pulleys. At least one of the one or more belt attachment devices is configured to couple the base frame to the timing belt of at least one of the timing belt systems at a belt attachment location.

### CROSS-REFERENCE TO RELATED APPLICATION

This application claims the benefit under 35 U.S.C. § 119 (e) of U.S. Patent Application No. 63/598,015, entitled “Refuse Loading System With Horizontal Positioning,” filed Nov. 10, 2023, which is incorporated herein by reference in its entirety.

### BACKGROUND

Mechanical arms are used to perform automated collection of garbage bins and dumping of the content of the garbage bins in a container of a corresponding refuse collection vehicle (RCV). The components and sub-systems used in mechanical arms are typically heavy, noisy, and impart significant vibration and impact loads on the refuse vehicle and its operators. Such mechanical arms may suffer from efficiency or durability issues. In addition, the high number of cycles under such loads impose physical burdens (e.g., driver fatigue) on operators of the vehicles.

### SUMMARY

Implementations of the present disclosure are generally directed to systems and methods for loading refuse into an RCV.

In a general aspect of the disclosure, a system for loading refuse includes a refuse loading system and a horizontal positioning system. The refuse loading system is configured to empty refuse into a refuse collection vehicle. The horizontal positioning system is configured to couple between the refuse loading system and a frame of the refuse collection vehicle. The horizontal positioning system includes a base section, an intermediate section, a distal section, a first timing belt system, a second timing belt system, a first belt attachment device, a second belt attachment device, a third belt attachment device, and one or more horizontal drive units. The base section is configured to couple to a frame of the refuse collection vehicle. The intermediate section is coupled to the base section and configured to translate with respect to the base section. The distal section is coupled between the intermediate section and the refuse loading system and configured to translate with respect to the intermediate section and the base section. The first timing belt system includes a first pair of timing pulleys spaced horizontally from one another and each is rotatably coupled to the base section, and a first timing belt is coupled in a loop around the first pair of timing pulleys. The second timing belt system includes a second pair of timing pulleys spaced horizontally from one another and each rotatably coupled to the intermediate section. The second timing belt is coupled around the second pair of timing pulleys. The first belt attachment device is configured to couple the intermediate frame to the first timing belt at a first belt attachment location. The second belt attachment device is configured to couple the base frame to the second timing belt at a second belt attachment location. The third belt attachment device is configured to couple the distal frame to the second timing belt at a third belt attachment location. The one or more horizontal drive units are operable to rotate at least one of the timing pulleys of the first pair of timing pulleys such that the distal section translates horizontally with respect to the base section.

In some implementations, at least one of the one or more horizontal drive units includes an electric motor.

In some implementations, at least one of the horizontal drive units is operable to extend the distal section away from the frame of the refuse collection vehicle.

In some implementations, at least one of the horizontal drive units is operable to retract the distal section toward the frame of the refuse collection vehicle.

In some implementations, the horizontal positioning system further includes one or more pairs of rail systems is coupled between the base section and the distal section.

In some implementations, at least one of the pairs of rail systems is coupled to the base section such that an offset is defined between a proximal end of a first one of the rail systems and a proximal end of the other one of the rail systems along the extend/retract axis. At least one of the one or more horizontal drive units is operable to translate the distal section horizontally with respect to the base section along the extend/retract axis.

In some implementations, at least one of the one or more horizontal drive units is at least partially in the offset.

In some implementations, at least one of the one or more horizontal drive units includes an electric motor. At least a portion of the electric motor is in the same horizontal plane as least a portion of at least one of the one or more rail systems.

In some implementations, at least one of the pairs of rail systems includes one or more pairs of roller assemblies spaced apart from one another.

In some implementations, at least one of the attachment devices includes an attachment block including two or more teeth configured to engage with two or more complementary teeth of one of the timing belts.

In some implementations, the refuse loading system includes a grabber system configured to engage a refuse container and a container lift mechanism. The container lift mechanism is coupled between the grabber system and the horizontal positioning system. The container lift mechanism is operable to lift a refuse container held by the grabber system to empty contents of the refuse container into the refuse collection vehicle.

In some implementations, the container lift mechanism includes a mast, a timing belt system, a fourth belt attachment device, and one more vertical drive units. The mast includes one or more vertical rails. At least one of the vertical rails includes one or more guides configured to guide the grabber system on the mast. The timing belt system includes a third pair of timing pulleys spaced vertically from one another and each is rotatably coupled to the mast. The third timing belt is coupled around the third pair of timing pulleys. The fourth belt attachment device is configured to couple the grabber system to the third timing belt. The one or more vertical drive units are configured to rotate at least one of the timing pulleys such that the timing belt pulls the grabber system up the mast.

In some implementations, at least one of the one or more guides includes arcuate guide portion configured to tip the refuse container as the grabber system is raised to empty contents of the refuse container into a receptacle of the refuse collection vehicle.

In some implementations, at least one of the vertical drive units includes an electric motor.

In some implementations, the grabber system includes a grabber system drive unit operable to engage a pair of opposing arms with the refuse container.

In some implementations, the grabber system drive unit includes an electric motor.

In a general aspect of the disclosure, a horizontal positioning system for a refuse loading system includes a base section, a distal section, one or more timing belt systems, one or more belt attachment devices, and one or more horizontal drive units. The base section is configured to couple to a frame of a refuse collection vehicle. The distal section is configured to couple between the base section and the refuse loading system and configured to translate with respect to the base section. At least a first one of the timing belt systems includes a pair of timing pulleys spaced horizontally from one another and each is rotatably coupled to the base section, and a timing belt is coupled around the pair of timing pulleys. At least one of the one or more belt attachment devices is configured to couple the base frame to the timing belt of at least one of the timing belt systems at a belt attachment location. The one or more horizontal drive units are operable to rotate at least one of the timing pulleys such that the distal section translates horizontally with respect to the base section.

In some implementations, at least one of the one or more belt attachment devices includes a pair of attachment blocks. One of the timing belts is held between the attachment blocks.

In some implementations, at least one of the one or more belt attachment devices includes a pair of attachment blocks. One or more of the attachment blocks includes two or more teeth configured to engage complementary teeth on a timing belt.

In some implementations, at least one of the one or more belt attachment devices includes two or more fasteners configured to secure a section of one of the timing belts to the belt attachment device.

In some implementations, at least one of the belt attachment devices includes one or more fasteners configured to pass through the timing belt.

In some implementations, an intermediate section is coupled between the base section and the distal section. The intermediate section is configured to translate relative to the base section and relative to the distal section.

In a general aspect of the disclosure, a method of loading refuse includes rotating a drive pulley engaged with a timing belt to horizontally translate a refuse loading system coupled to a section of the timing belt; and operating the refuse loading system to load refuse into a refuse collection vehicle.

In some implementations, the method includes, before rotating the drive pulley, clamping the section of the timing belt to couple the refuse loading system to the section of the timing belt.

In a general aspect of the disclosure, a system for loading refuse includes a refuse loading system and a horizontal positioning system. The refuse loading system is configured to load refuse into a refuse collection vehicle. The horizontal positioning system is configured to couple between the refuse loading system and a frame of the refuse collection vehicle. The horizontal positioning system includes a base section, a distal section, a pair of rail systems, and one or more horizontal drive units. The base section is configured to couple to a frame of refuse collection vehicle. The distal section is coupled between the base section and the refuse loading system and configured to translate with respect to the base section. The pair of rail systems is coupled between the base section and the distal section. The pair of rail systems is configured such that the distal section is translatable relative to the base section along an extend/retract axis. The pair of rail systems is coupled to the base section such that an offset is defined between a proximal end of a first one of the rail systems and a proximal end of the other one of the rail systems along the extend/retract axis. The one or more horizontal drive units are operable to translate the distal section horizontally with respect to the base section along the extend/retract axis.

In some implementations, at least one of the horizontal drive units is at least partially in the offset.

In some implementations, at least one of the one or more horizontal drive units includes a drive motor; and at least a portion of the drive motor is in the same horizontal plane as least a portion of at least one of the rail systems.

In some implementations, the system includes a horizontal drive unit mounting bracket configured to hold at least one of the horizontal drive units and including a first leg including an opening through which a drive shaft of the horizontal drive unit passes, and a second leg extending between at least a portion of the horizontal drive unit and a proximal end of at least one of the rail systems.

In some implementations, at least one of the rail systems includes one or more roller assemblies. At least one of the roller assemblies engages on a rail coupled to the base section or a rail coupled to the distal section.

In some implementations, at least one of the roller assemblies includes an in-line double roller.

In some implementations, the one or more roller assemblies includes two or more roller assemblies spaced from one another.

In some implementations, at least one of the horizontal drive units includes a direct drive motor.

In some implementations, at least one of the horizontal drive units includes an electric motor.

In some implementations, the system includes one or more timing belt systems and one or more belt attachment devices. At least a first one of the timing belt systems includes a pair of timing pulleys spaced horizontally from one another and each is rotatably coupled to the base section. A timing belt is coupled in a loop around the pair of timing pulleys. At least one of the one or more belt attachment devices is configured to couple the base frame to the timing belt at a belt attachment location. At least one of the horizontal drive units is configured to rotate at least one of the timing pulleys such that the distal section translates horizontally with respect to the base section.

In a general aspect of the disclosure, a system for loading refuse includes a refuse loading system and a horizontal positioning system. The refuse loading system configured to empty refuse into a refuse collection vehicle. The horizontal positioning system configured to couple between the refuse loading system and a frame of the refuse collection vehicle. The horizontal positioning system includes a base section, an intermediate section, a distal section, and one or more conveyance systems. The base section is configured to couple to a frame of the refuse collection vehicle. The intermediate section is coupled to the base section and translatable relative to the base section. The distal section is coupled between the intermediate section and the refuse loading system and translatable relative to the intermediate section and the base section. The one or more conveyance systems include a first arcuate support, a second arcuate support, a first flexible tether, a second flexible tether, and a drive unit. The first arcuate support and the second arcuate support are both coupled to the intermediate section. The first flexible tether engages the first arcuate support and is fixed to both the base section and the distal section. The second flexible tether engages the second arcuate support and is fixed to both the base section and the distal section. The drive unit is configured to drive translation of the intermediate section relative to the base section. The translation of the intermediate section relative to the base section causes movement of the first flexible tether and the second flexible tether that translates the distal section relative to the intermediate section and the base section.

In some implementations, the drive unit comprises an electric motor.

In some implementations, at least one of the first flexible tether or the second flexible tether comprises a chain.

In some implementations, at least one of the first arcuate support or the second arcuate support comprises a sprocket.

In some implementations, each of the first flexible tether and the second flexible tether comprises a respective timing chain.

In some implementations, each of the first arcuate support and the second arcuate support comprises a respective timing sprocket.

In some implementations, at least one of the first flexible tether or the second flexible tether comprises a belt.

In some implementations, at least one of the first arcuate support or the second arcuate support comprises a pulley.

In some implementations, each of the first flexible tether and the second flexible tether comprises a respective timing belt.

In some implementations, each of the first arcuate support and the second arcuate support comprises a respective timing pulley.

In some implementations, at least one of the first flexible tether or the second flexible tether comprises a band.

In some implementations, at least one of the first flexible tether or the second flexible tether comprises a cable.

In some implementations, at least one of the first flexible tether or the second flexible tether comprises a rope.

In some implementations, at least one of the first arcuate support or the second arcuate support comprises a pulley.

In some implementations, the first flexible tether and the second flexible tether are of a same type, selected from a group comprising chains, belts, bands, cables, and ropes.

In some implementations, the first flexible tether and the second flexible tether are of a different type, selected from a group comprising chains, belts, bands, cables, and ropes.

In some implementations, the one or more conveyance systems further include a first attachment device and a second attachment device. The first attachment device is configured to couple the first flexible tether and the second flexible tether to the base section. The second attachment device is configured to couple the first flexible tether and the second flexible tether to the distal section.

In some implementations, the first flexible tether comprises a first end portion coupled with the first attachment device, and a second end portion coupled with the second attachment device. In some implementations, the second flexible tether comprises a third end portion coupled with the first attachment device, and a fourth end portion coupled with the second attachment device.

In some implementations, the first flexible tether and the second flexible tether are separated from having direct contact with one another.

In some implementations, at least one of the first attachment device or the second attachment device is configured to couple the first flexible tether with the second flexible tether, such that, when a respective end portion of the first flexible tether and a respective end portion of the second flexible tether are attached to the at least one of the first attachment device or the second attachment device, the respective end portion of the first flexible tether and the respective end portion of the second flexible tether extend along a common axis that is parallel to a direction of translation of the intermediate section.

In some implementations, at least one of the first attachment device or the second attachment device is configured to couple the first flexible tether with the second flexible tether, such that, when a respective end portion of the first flexible tether and a respective end portion of the second flexible tether are attached to the at least one of the first attachment device or the second attachment device, the respective end portion of the first flexible tether extends along a first axis that is parallel to a direction of translation of the intermediate section, and the respective end portion of the second flexible tether extends along a second axis, which is distanced from the first axis and also parallel to the direction of translation of the intermediate section.

In some implementations, the one or more conveyance systems further comprise a rack and pinion mechanism.

In some implementations, the rack and pinion mechanism includes a pinion gear and a rack. The pinion gear is driven by the drive unit. The drive unit is stationary relative to the base section. The rack includes teeth that mesh with the pinion gear. The rack is coupled with the intermediate section or integrally formed with the intermediate section.

Particular implementations of the subject matter described in this specification can be implemented so as to realize one or more of the following advantages.

Implementations of the present disclosure may make loading of refuse more energy efficient.

Implementations of the present disclosure may reduce discomfort, noise, jarring, vibration, and other physical burdens encountered by operators of refuse collection vehicles.

Implementations of the present disclosure may reduce operator fatigue.

Implementations of the present disclosure may reduce the need for expensive, complex components with high maintenance costs.

Implementations of the present disclosure may result in a lower profile mechanism.

Implementations of the present disclosure may increase maintainability of loading refuse into a waste collection system.

Implementations of the present disclosure may increase effectiveness of loading refuse into a waste collection system.

In a general aspect of the disclosure, a refuse collection vehicle includes one or more implementations of the system for loading refuse described in the present disclosure.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a refuse vehicle that includes a refuse loading system according to some implementations.

FIG. 2 is a perspective view of a refuse loading system according to some implementations.

FIG. 3 is a perspective view of the refuse loading system as viewed from above the horizontal positioning system.

FIG. 4 is a perspective view of the proximal end of the horizontal positioning system.

FIG. 5 is a top view of a horizontal positioning system according to some implementations.

FIG. 6 is a perspective view of the distal end of the base timing belt system and intermediate timing belt system shown in FIGS. 3 and 4.

FIG. 7 is a perspective view of the proximal end of the base timing belt system and intermediate timing belt system shown in FIGS. 3 and 4.

FIG. 8 is a perspective view of the horizontal positioning system with a cross section taken through a base timing belt system.

FIG. 9 is a perspective view of the horizontal positioning system with a cross section taken through an intermediate timing belt system.

FIG. 10 is a top view of the horizontal positioning system in an extended state.

FIG. 11 is a perspective view from the curb side and to the rear of a horizontal positioning system in a partially extended state.

FIG. 12 illustrates an attachment device for connecting a timing belt to the distal section assembly of a refuse loading system according to some implementations.

FIG. 13 is a partially exploded view of a device for attaching a timing belt to the base section assembly of a refuse loading system.

FIG. 14 illustrates a tensioning adjustment device for a timing belt system in some implementations.

FIG. 15 is a perspective view of a refuse container emptying system according to some implementations.

FIG. 16 is a side view of refuse container emptying system.

FIG. 17 is a cross sectional view illustrating a timing belt system of a container lift mechanism according to some implementations.

FIG. 18 is a perspective view of a grabber system.

FIG. 19 illustrates a connection of a grabber system to a timing belt system of a container lift mechanism.

FIG. 20 is a cross sectional view illustrating a connection of a grabber system to a timing belt according to some implementations.

FIG. 21 is a perspective view illustrating a belt attachment device on a timing belt.

FIG. 22 is an exploded view of an attachment device that can be used to attach a grabber system to a timing belt.

FIG. 23 illustrates an upper portion of timing belt system according to some implementations.

FIG. 24 illustrates an upper timing pulley of a container lift mechanism according to some implementations.

FIGS. 25A, 25B, and 25C illustrate raising of a grabber system on a refuse container lift mechanism.

FIG. 26 is a perspective front view of a mast of a container lift mechanism.

FIG. 27 is a rear perspective view of a container lift mechanism.

FIG. 28 is a cross sectional view showing a lower timing pulley of a container lift mechanism.

FIG. 29 is a perspective view illustrating a bottom roller stop according to some implementations.

FIG. 30 is a front perspective view of a grabber system according to some implementations.

FIG. 31 is a rear perspective view of the grabber system shown in FIG. 30.

FIG. 32 illustrates a grabber gearbox according to some implementations.

FIG. 33 is a partial cross-sectional view of a grabber system according to some implementations.

FIG. 34 is a perspective view of a frame for a grabber system.

FIG. 35 includes a schematic side view of an example conveyance system for a horizontal positioning system that includes multiple flexible tethers according to some implementations.

FIG. 36 is a perspective view of an example attachment device for coupling multiple flexible tethers to a portion of a horizontal positioning system according to some implementations.

FIG. 37 is a side view of another example attachment device for coupling multiple flexible tethers to a portion of a horizontal positioning system according to some implementations.

FIG. 38 is a perspective view of yet another example attachment device for coupling multiple flexible tethers to a portion of a horizontal positioning system according to some implementations.

FIG. 39 depicts an example computing system, according to implementations of the present disclosure.

### DETAILED DESCRIPTION

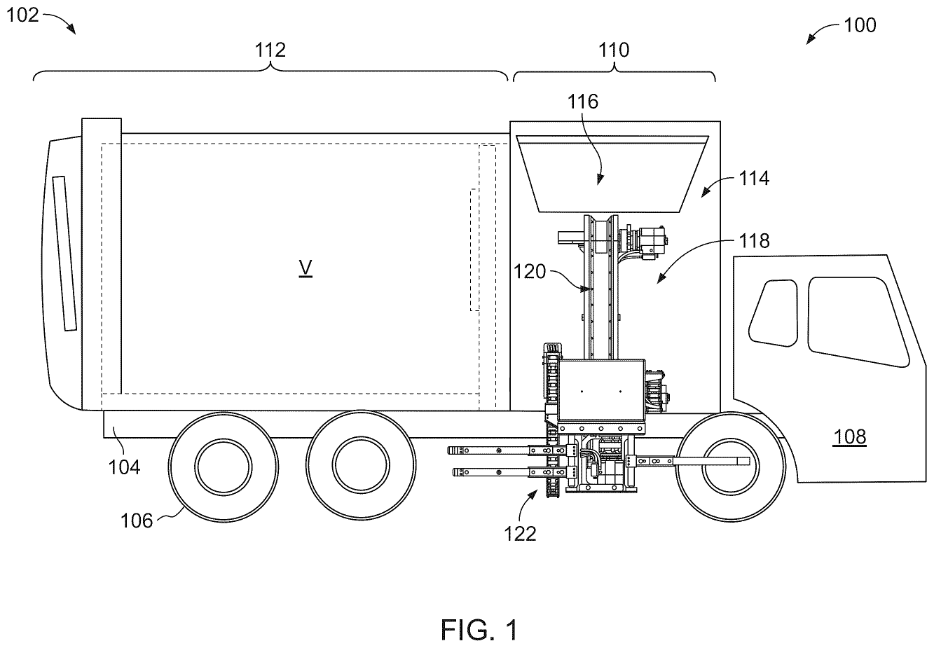

Implementations of the present disclosure are directed to systems, devices, and methods for loading refuse. FIG. 1 illustrates a refuse vehicle that includes a refuse loading system according to some implementations. Refuse vehicle 100 includes waste collection device 102, frame 104, wheels 106, and cab 108. Waste collection device 102 includes waste intake portion 110 and waste storage portion 112.

Waste intake portion 110 includes refuse loading system 114 and hopper 116. Refuse loading system 114 is operable to transfer the contents of refuse containers into waste collection device 102 via hopper 116. Waste collection device can include a packing device (not shown in FIG. 1). The packing device can pack refuse loaded into the hopper, push refuse toward the rear of the refuse vehicle (e.g., to waste storage portion 112), and/or eject refuse from the refuse vehicle.

Refuse loading system 114 includes refuse container emptying system 118. Refuse container emptying system 118 includes container lift mechanism 120 and grabber 122. Grabber 122 can be operated to couple to a refuse container. Container lift mechanism 120 can be operated to lift the refuse container and tip and dump contents of the refuse container into hopper 116.

Refuse vehicle 100 can be an RCV that operates to collect and transport refuse (e.g., garbage). The refuse collection vehicle can also be described as a garbage collection vehicle, or garbage truck. Refuse vehicle 100 can be configured to lift containers that contain refuse and empty the refuse in the containers into a hopper of the refuse vehicle 100 and/or intermediate collection device conveyed by the RCV, to enable transport of the refuse to a collection site, compacting of the refuse, and/or other refuse handling activities. Refuse vehicle 100 can also handle containers in other ways, such as by transporting the containers to another site for emptying.

In some implementations, refuse vehicle 100 is an all-electric vehicle. Motive power and various body controls and sub-systems on the vehicle (including refuse loading system 114, a packing system, an ejector system, a contamination detection system) can be electrically powered.

### Horizontal Positioning System

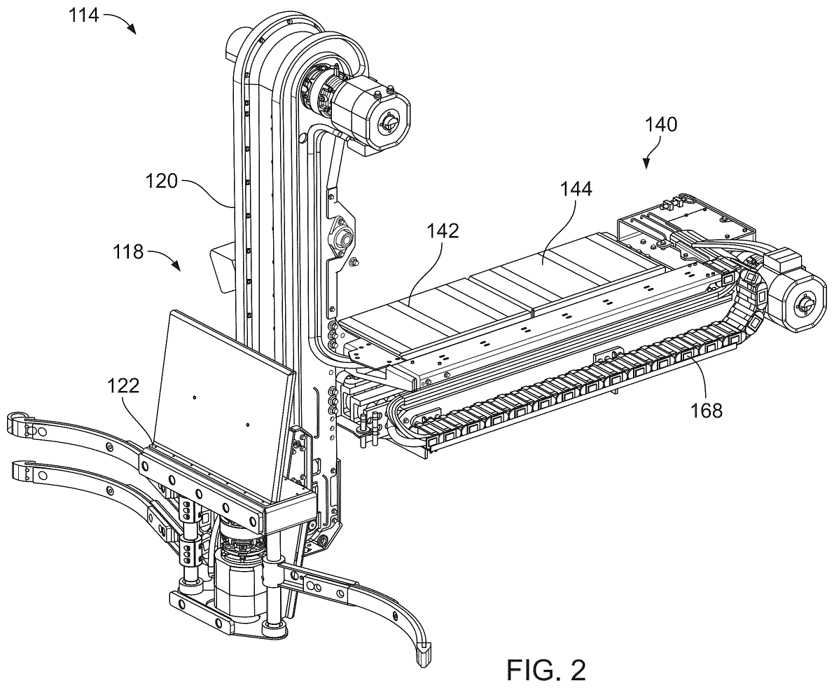

FIG. 2 is a perspective view of a refuse loading system according to some implementations. Refuse loading system 114 includes horizontal positioning system 140 and refuse container emptying system 118. Refuse container emptying system 118 includes container lift mechanism 120 and grabber 122. Horizontal positioning system 140 is mounted to the frame of the refuse vehicle 100 (not shown in FIG. 2). Horizontal positioning system 140 can be operated to position refuse container emptying system 118 relative to the body of refuse vehicle 100. Horizontal positioning system 140 can have a retracted position and one or more extended positions. Horizontal positioning system 140 is operable to position refuse container emptying system 118 directly in front of a refuse container so that the refuse container can be lifted so the contents of the refuse container can be emptied into hopper 116.

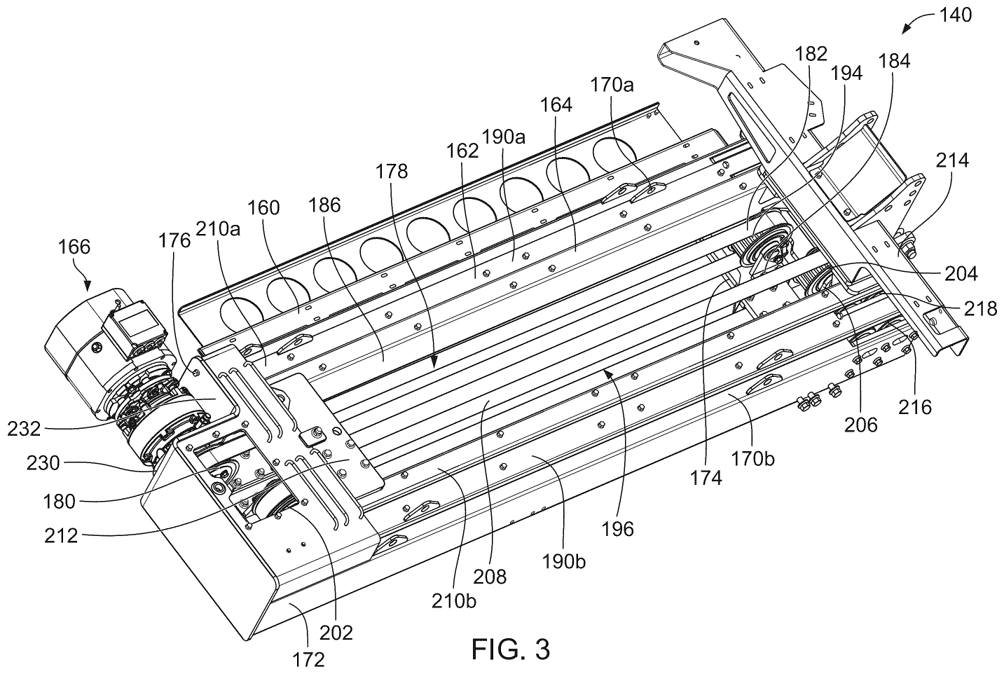

As also discussed herein with reference to at least FIGS. 3-15 and 35-38, horizontal positioning system 140 includes multiple sections (e.g., a base section assembly, an intermediate section assembly, and/or a distal section assembly), with one or more sections being translatable relative to one or more other sections in various implementations. Horizontal positioning system 140 further includes one or more conveyance systems and one or more drive units. According to some implementations, a base section assembly of the horizontal positioning system 140 is mounted to the frame of the refuse vehicle. An intermediate section assembly is translatably coupled with the base section assembly. A distal section assembly is translatably coupled with the intermediate section assembly. Refuse container emptying system 118 is mounted on the distal section assembly. The conveyance system(s) can include, for example, pulleys, belts, sprockets, chains, rack and pinion mechanisms, ball screw mechanisms, hydraulic cylinders, linear actuators, cables, rails, and/or rollers, etc. The drive unit(s) are used to drive the conveyance system(s), enabling translation of one or more sections of horizontal positioning system 140 relative to one or more other sections of horizontal positioning system 140. As an example, the intermediate section assembly can translate relative to the base section assembly via at least a portion of the conveyance system(s). As another example, the distal section assembly can translate relative to the intermediate section assembly and/or the base section assembly via at least a portion of the conveyance system(s).

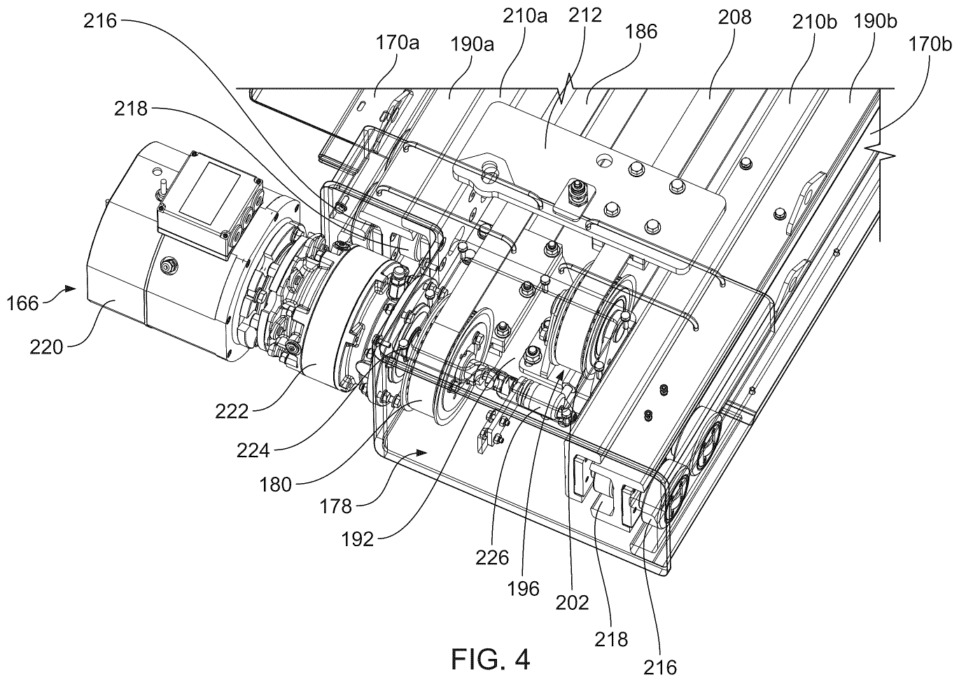

FIG. 3 is a perspective view of the refuse loading system as viewed from above the horizontal positioning system. FIG. 4 is a perspective view of the proximal end of the horizontal positioning system. Horizontal positioning system covers 142 and 144 (shown in FIG. 2) are omitted from FIGS. 3 and 4 for illustrative purposes.

In this example, horizontal positioning system 140 includes base section assembly 160, intermediate section assembly 162, distal section assembly 164, drive unit 166, and cable system 168. Base section assembly 160 is mounted to the frame of refuse vehicle 100. Horizontal positioning system 140 can be installed such that it is partially or completely underneath hopper 116. Intermediate section assembly 162 is translatably coupled to base section 160. Distal section assembly 164 is translatably coupled to intermediate section assembly 162. Refuse container emptying system 118 is mounted on distal section assembly 164.

Base section assembly 160 includes a pair of spaced rails 170a, 170b, proximal-end base plate 172, distal-end base plate 174, drive unit mounting bracket 176, and base timing belt system 178. Base timing belt system 178 includes base proximal pulley 180, base distal pulley 182, base distal pulley mount 184, and base timing belt 186. Spaced rails 170a, 170b are mounted parallel to one another. In the context of the present disclosure, “proximal” and “distal” are in reference to a distance from the body of the refuse vehicle, with “proximal” being relatively closer to the body of the vehicle and “distal” being relatively farther away from the body of the vehicle.

Intermediate section assembly 162 includes a pair of spaced rails 190a, 190b, intermediate proximal cross member 192, intermediate distal cross member 194, and intermediate timing belt system 196. Intermediate timing belt system 196 includes intermediate proximal pulley 200, intermediate proximal pulley mount 202, intermediate distal pulley 204, intermediate distal pulley mount 206, and intermediate timing belt 208. Spaced rails 190a, 190b are mounted parallel to one another.

Distal section assembly 164 includes a pair of spaced rails 210a, 210b, distal cross member 212, and mounting bracket 214. Spaced rails 210a, 210b are mounted parallel to one another. Container lift mechanism 120 of refuse container emptying system 118 (shown in FIG. 2) is bolted to mounting bracket 214 of distal section assembly 164.

Intermediate section assembly 162 is coupled for translation in and out on base section assembly 160. In this manner, refuse container emptying system 118 can be alternately positioned farther from, or closer to, the body of refuse vehicle 100. For example, refuse container emptying system 118 can be extended out to where a curb-side refuse container is situated for pick up. Intermediate section assembly 162 includes rollers 216. Rollers 214 engage on rails 170a, 170b of base section assembly 160.

Distal section assembly 164 is coupled for translation in and out on intermediate section assembly 162. Distal section assembly 164 includes rollers 216. Rollers 216 engage on rails 190a, 190b of intermediate section assembly 162. Refuse loading system 114 is fully extended when intermediate section assembly 162 is fully extended on base section assembly 160 and distal section assembly 164 is fully extended on intermediate section assembly 162.

Drive unit 166 is coupled to base proximal pulley 180. As is further described below, drive unit 166 can be operated to turn base proximal pulley 180 to move base timing belt 186 to extend and retract refuse loading system 114.

Drive unit 166 includes motor 220, gearbox 222, shaft assembly 224, and encoder device 226. In the implementation shown in FIG. 3, motor 220 is an electric motor. Drive unit 166 is mounted on drive unit mounting bracket 176 of base section assembly 160. Encoder device 226 is coupled to shaft assembly 224. Encoder device 226 can sense angular position of the motor shaft. A shaft of motor 220 drives an input shaft of gearbox 222. Gearbox 222 can be coupled to shaft assembly 224. In some implementations, shaft assembly 224 is include as part of gearbox 222. In some implementations, gearbox 222 includes a planetary gear system.

Drive unit mounting bracket 176 includes first leg 230 and second leg 232. First leg 230 and second leg 232 can be perpendicular to one another. First leg 230 includes an aperture through which a rotating shaft of the drive unit 166 passes. In the example shown in FIG. 3, drive unit mounting bracket 176 holds drive unit 166 such that at least a portion of the motor and gearbox are co-planar with a portion of the rails of base section assembly 160, intermediate section assembly 162, and distal section assembly 164.

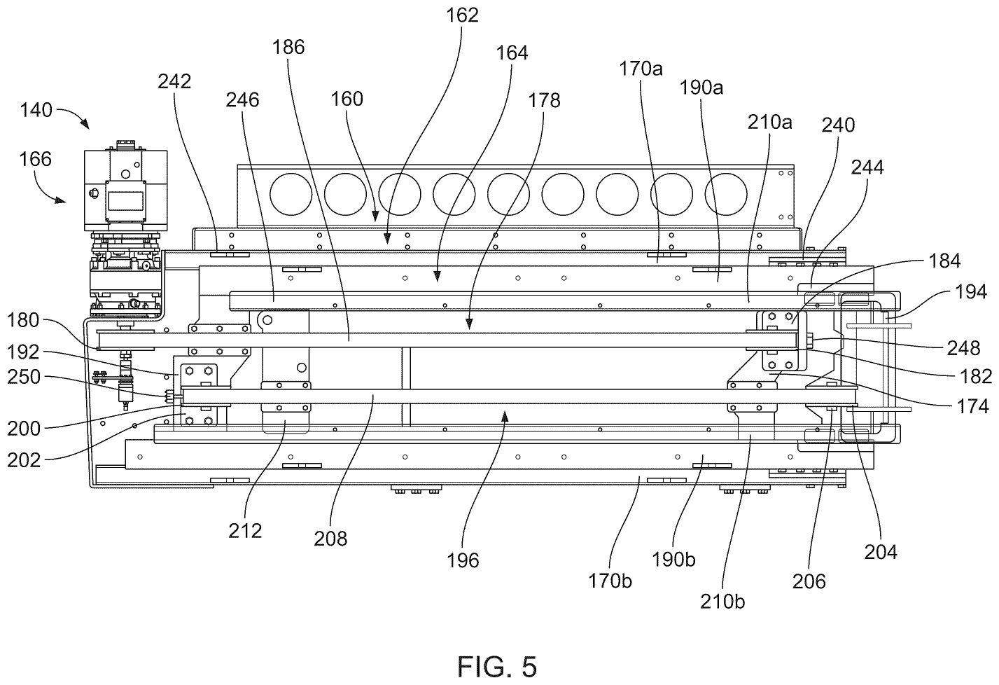

FIG. 5 is a top view of a horizontal positioning system according to some implementations. Intermediate section assembly 162 is coupled for translation in and out on base section assembly 160. Distal section assembly 164 is coupled for translation in and out on intermediate section assembly 162.

Intermediate section assembly 162 includes double roller assemblies 240, 242. Distal section assembly 164 includes double roller assemblies 244, 246. Each of double roller assemblies includes a pair of rollers spaced axially from one another along the rail with which the roller assembly is engaged. Double roller assemblies 240, 242 engage on rails 170a, 170b of base section assembly 160. Double roller assemblies 244, 246 engage on rails 190a, 190b of intermediate section assembly 162.

Double roller assembly 242 is offset in a distal direction along the length of rail 190a relative to the location of double roller assembly 242 on rail 190b on the opposite side of intermediate section assembly 162. Thus, the distance between double roller assemblies 240 and 242 on rail 190a is less than the distance between double roller assemblies 240 and 242 on rail 190b.

Double roller assembly 246 is offset in a distal direction along the length of rail 210a relative to the location of double roller assembly 244 on rail 210b on the opposite side of distal section assembly 164. Thus, the distance between double roller assemblies 244 and 246 on rail 210a is less than the distance between double roller assemblies 244 and 246 on rail 210b.

The offset of double roller assembly 242 along the length of rail 190a and offset of double roller assembly 246 along the length of rail 210a provides space for drive unit 166 to be in the same plane as the rails of horizontal positioning system 140.

Base timing belt system 178 is provided on base section assembly 160. In this example, base proximal pulley 180 is mounted on the output shaft of drive unit 226. Base distal pulley 182 is mounted on distal-end base plate 174 by way of base distal pulley mount 184. The spacing between base proximal pulley 180 and base distal pulley 182 is fixed during operation of horizontal positioning system 140. Tensioning adjustment device 248 can be used increase or decrease spacing between the pulleys to adjust tension on base timing belt 186.

Intermediate timing belt system 196 is provided on intermediate section assembly 162. Intermediate proximal pulley 200 is mounted on intermediate proximal cross member 192 by way of intermediate distal pulley mount 202. Intermediate distal pulley 204 is mounted on intermediate distal cross member 194 by way of intermediate distal pulley mount 206. The spacing between intermediate proximal pulley 200 and intermediate distal pulley 204 is fixed during operation of horizontal positioning system 140. Tensioning adjustment device 250 can be used increase or decrease spacing between the pulleys to adjust tension on intermediate timing belt 208.

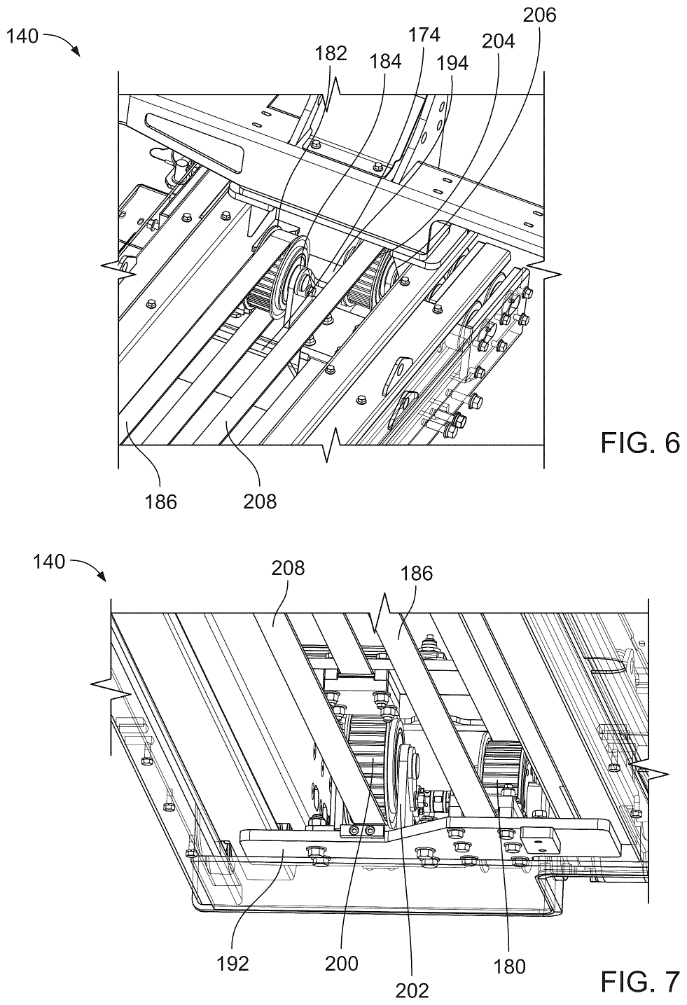

FIG. 6 is a perspective view of the distal end of the base timing belt system and intermediate timing belt system shown in FIGS. 3 and 4. Base distal pulley 182 is coupled to distal-end base plate 174 by way of base distal pulley mount 184. Base timing belt 186 is installed on and operably engaged with base distal pulley 182. Intermediate distal pulley 204 is mounted on intermediate distal cross member 194 by way of intermediate distal pulley mount 206. Intermediate timing belt 208 is installed on and operably engaged with intermediate distal pulley 204.

FIG. 7 is a perspective view of the proximal end of the base timing belt system and intermediate timing belt system shown in FIGS. 3 and 4. Base proximal pulley 180 is coupled to the output shaft of drive unit 166 (shown in FIG. 2). Base timing belt 186 is installed on and operably engaged with base proximal pulley 180. Intermediate proximal pulley 200 is mounted on intermediate proximal cross member 192 by way of intermediate proximal pulley mount 202. Intermediate timing belt 208 is installed on and operably engaged with intermediate proximal pulley 200.

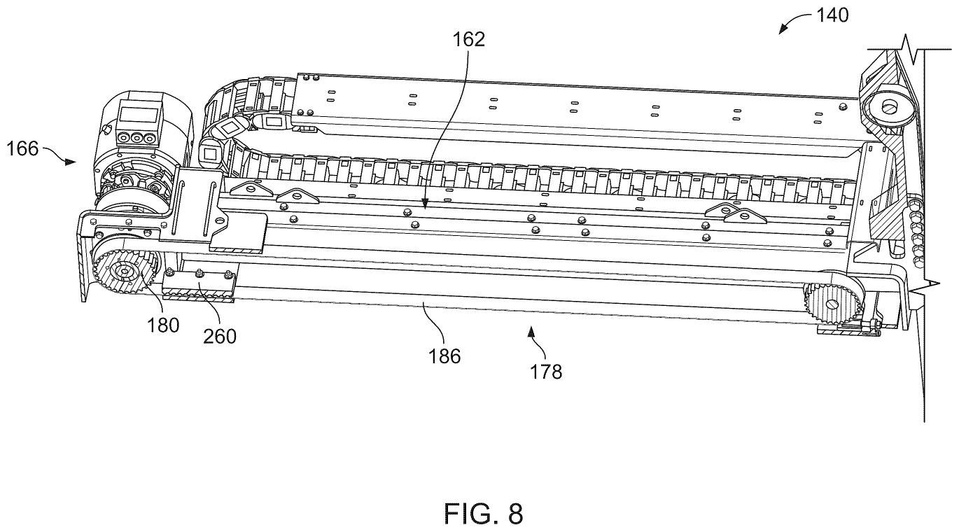

FIG. 8 is a perspective view of the horizontal positioning system with a cross section taken through base timing belt system 178. Intermediate section assembly 162 is coupled to base timing belt 186 of base timing belt system 178 along the length of base timing belt 186 at attachment point 260. As base timing belt 186 moves, intermediate section assembly 162 moves in the same direction as attachment point 260. In this manner, rotation of base proximal pulley 180 moves intermediate section assembly 162 in or out relative to the body of refuse vehicle 100.

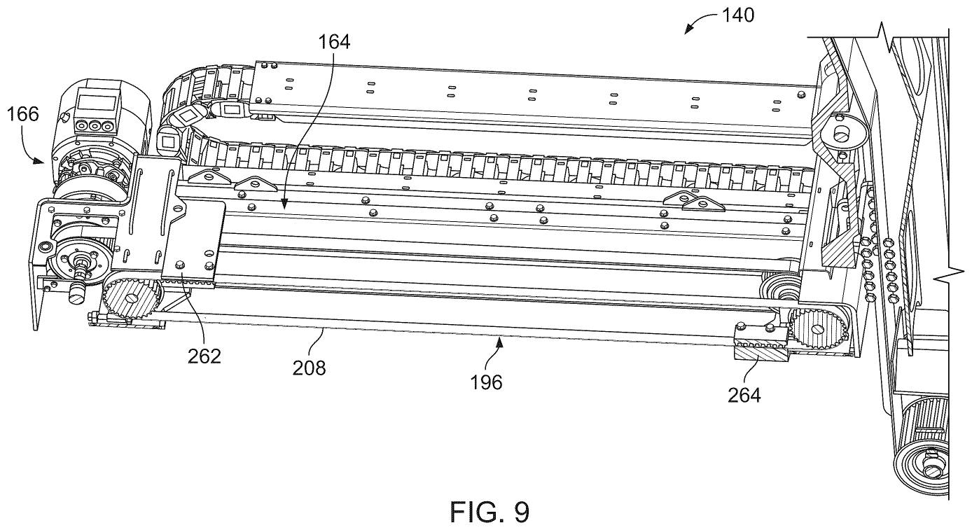

FIG. 9 is a perspective view of the horizontal positioning system with a cross section taken through intermediate timing belt system 196. Distal section assembly 164 is coupled to intermediate timing belt 208 of intermediate timing belt system 196 along the length of intermediate timing belt 208 at attachment point 262. Another portion of intermediate timing belt 208 is secured to base section assembly 160 at attachment point 264. As intermediate timing belt 208 moves, distal section assembly 164 moves in the same direction as attachment point 262, while attachment point 264 remains fixed with respect to the body of refuse vehicle 100. In this manner, as base proximal pulley 180 (shown in FIG. 8) is turned by drive unit 166 and intermediate section assembly 162 moves in and out relative to the body of refuse vehicle 100, distal section assembly 164 also moves in and out relative to the body of refuse vehicle 100.

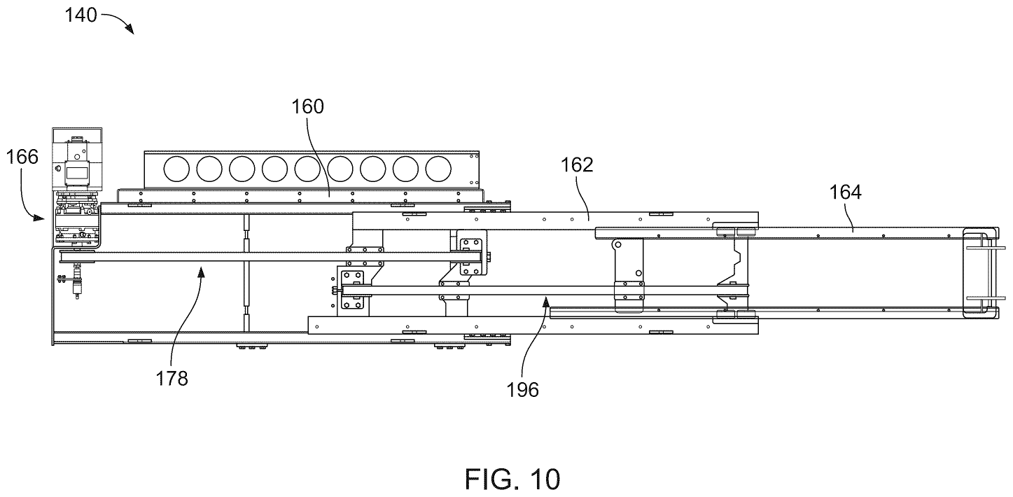

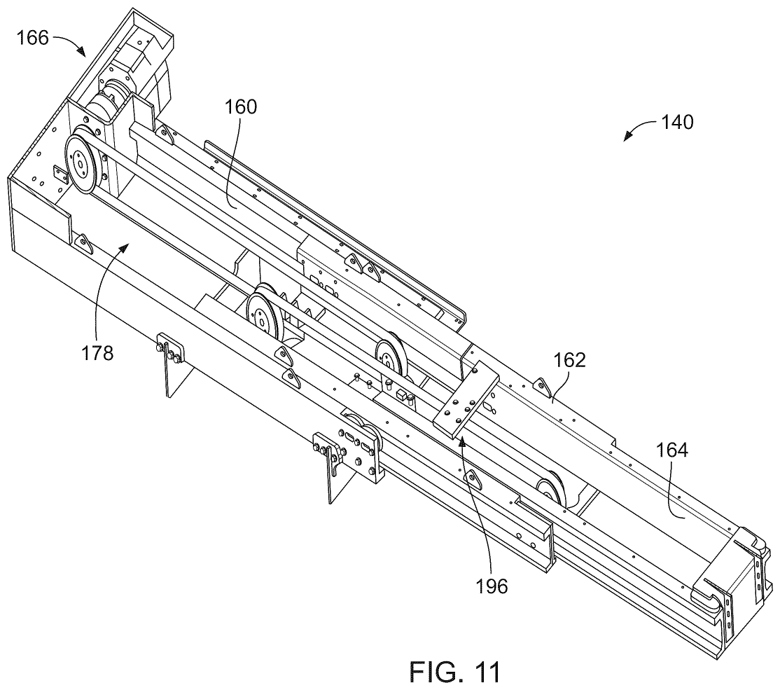

FIG. 10 is a top view of the horizontal positioning system in an extended state. FIG. 11 is a perspective view from the curb side and to the rear of a horizontal positioning system in a partially extended state. In the extended state, intermediate section assembly 162 has been extended from base section assembly 160 by operation of base timing belt system 178, and distal section assembly 164 has been extended from intermediate section assembly 162 by operation of intermediate timing belt system 196.

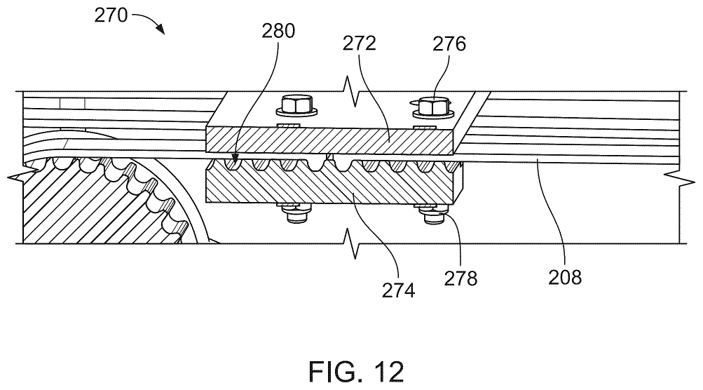

In various implementations, a system includes attachment devices to attach a component a section of a belt such that the component moves with the section of the belt at the attachment point. In some implementations, the belt moves the component in a non-continuous manner between two pulleys of a belt system. For example, one or more pulleys can be driven in one direction to move the attachment device and the attached component a portion of the distance between the two pulleys, then driven in the reverse direction to return the attachment device and attachment components to their original location. FIG. 12 illustrates an attachment device for connecting a timing belt to the distal section assembly of a refuse loading system according to some implementations. Attachment device 270 includes base portion 272, attachment plate 274, bolts 276, and nuts 278. Attachment plate 272 includes teeth 280. The teeth engage on corresponding teeth of intermediate timing belt 208. In some cases, the attachment device 270 connects the ends of the timing belt with one another.

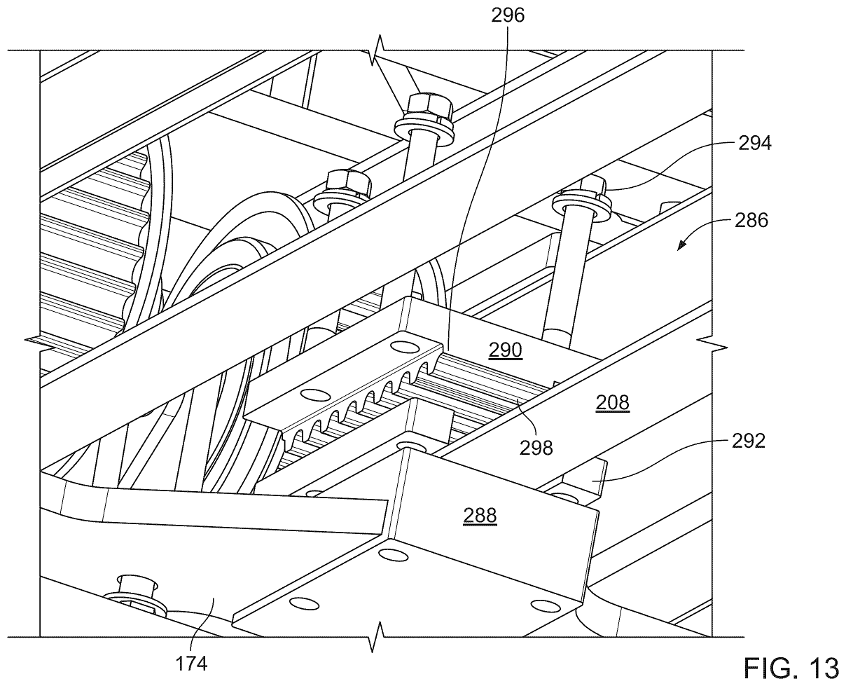

FIG. 13 is a partially exploded view of a device for attaching a timing belt to the base section assembly of a refuse loading system. Attachment device 286 includes mounting block 288, attachment plate 290, spacer 292, and bolts 294. Attachment plate 290 includes boss 296. Boss 296 includes teeth 298. Bolts 294 are installed to secure attachment plate 290 such that teeth 298 engage with corresponding teeth on intermediate timing belt 208.

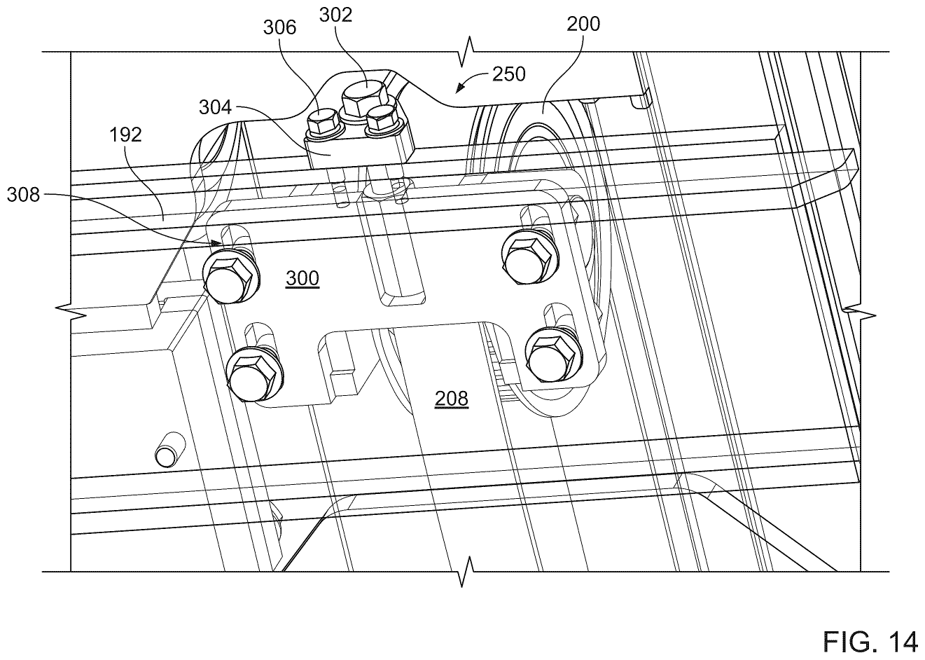

In the implementation shown in FIGS. 13 and 14, the teeth are on the attachment plate, and the component to which the belt is secured has a flat surface. In other implementations, the teeth of a timing belt can face the component to be secured to the belt, rather than the attachment plate. In this case, the component-side of the interface can include teeth that engage corresponding teeth on the timing belt.

FIG. 14 illustrates a tensioning adjustment device for a timing belt system in some implementations. Tensioning adjustment device 250 includes plate 300, center bolt 302, adjustment block 304, and side adjustment screws 306. Plate 300 includes slots 308. Plate 300 is attached to distal cross member of intermediate section assembly 162. Center bolt 302 and side adjustment screws 306 can each be adjusted independently. Center bolt 302 and side adjustment screws can be adjusted to control the distance between the two pulleys of the timing belt system and make angular adjustments of plate 300 to control the angle of the timing pulley relative to the timing belt.

In the implementations shown above, the refuse loading system includes a motor on the proximal end of a horizontal positioning system. In other implementations, a drive motor can be in another location. For example, a motor can be mounted on one of the moving sections of the system (e.g., an intermediate section or a distal section).

In some implementations, a drive unit of the packing device includes an outrunner/hub motor arrangement. In some implementations, a shell of an outrunner motor as includes teeth, grooves, or other features on the outer surface of the shell that directly engage on a belt. In this case, a separate timing pulley can be omitted.

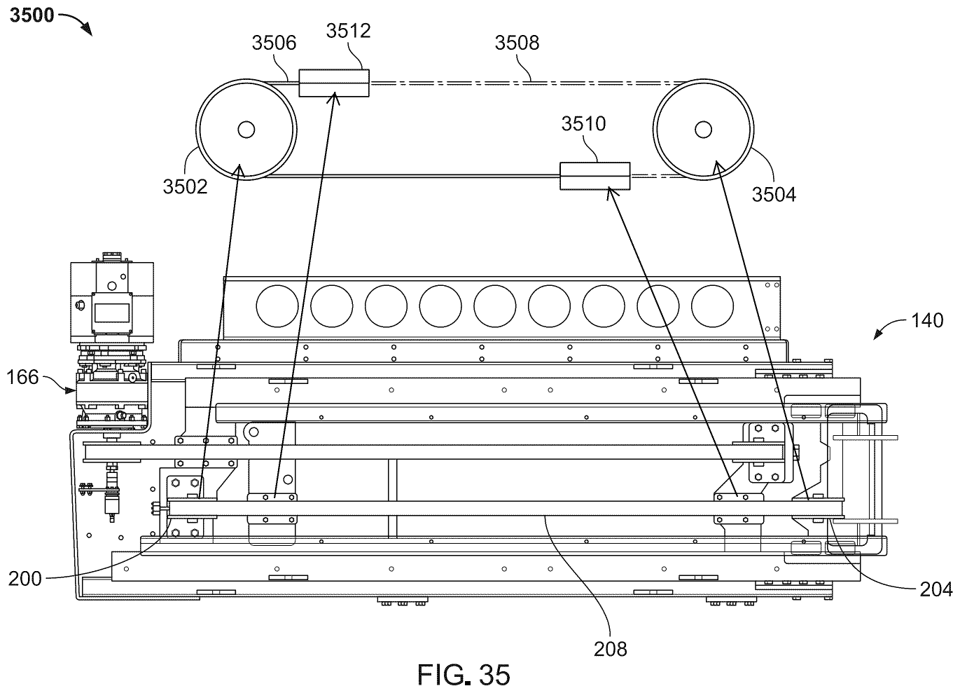

Various implementations of conveyance systems (and/or components of conveyance systems) that can be used in horizontal positioning system 140 are discussed herein with reference to FIGS. 35-38. For example, FIG. 35 illustrates a schematic side view of an example conveyance system 3500 that includes multiple flexible tethers according to some implementations. FIG. 35 also shows the top view of the horizontal positioning system 140 of FIG. 5, with arrows demonstrating exemplary components of the horizontal positioning system 140 that may generally correspond to various components of the conveyance system 3500.

The conveyance system 3500 includes a first arcuate support 3502, a second arcuate support 3504, a first flexible tether 3506, a second flexible tether 3508, a first attachment device 3510, and a second attachment device 3512. The first flexible tether 3506 engages the first arcuate support 3502. The second flexible tether 3508 engages the second arcuate support 3504. The first attachment device 3510 and the second attachment device 3512 couple the first flexible tether 3506 with the second flexible tether 3508.

As indicated in FIG. 35, the first arcuate support 3502 and the second arcuate support 3504 can be coupled to the intermediate section assembly 162 of the horizontal positioning system 140. The first attachment device 3510 can couple the first flexible tether 3506 and the second flexible tether 3508 to the base section assembly 160. The second attachment device 3512 can couple the first flexible tether 3506 and the second flexible tether 3508 to the distal section assembly 164.

A drive unit (e.g., drive unit 166) is configured to drive translation of the intermediate section assembly 162 relative to the base section assembly 160. The translation of the intermediate section assembly 162 relative to the base section assembly 160 causes movement of the first flexible tether 3506 and the second flexible tether 3508 that translates the distal section assembly 164 relative to the intermediate section assembly 162 and the base section assembly 160.

The flexible tethers can be implemented in a variety of different forms, including chains, timing chains, belts, timing belts, bands, cables, and/or ropes, etc. The first flexible tether 3506 and the second flexible tether 3508 can be of a same type in some implementations. The first flexible tether 3506 and the second flexible tether 3508 can be of a different type in other implementations. Similarly, the arcuate supports can be implemented in a variety of different forms, including pulleys, timing pulleys, sprockets, and/or timing sprockets, etc. The first arcuate support 3502 and the second arcuate support 3504 can be of a same type in some implementations. The first arcuate support 3502 and the second arcuate support 3504 can be of a different type in other implementations.

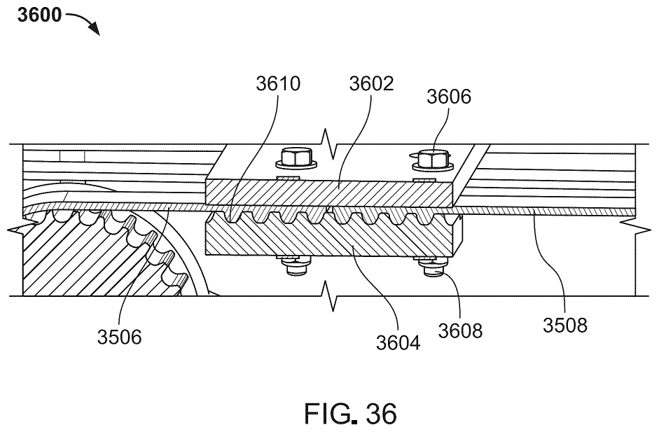

FIG. 36 illustrates a perspective view of an example attachment device 3600 for coupling multiple flexible tethers (e.g., the first flexible tether 3506 and the second flexible tether 3508 in FIG. 35) to a portion of a horizontal positioning system (e.g., horizontal positioning system 140) according to some implementations. Attachment device 3600 is an example of an attachment device that can be used as the first attachment device 3512 and/or the second attachment device 3510 described herein with reference to FIG. 35. While the example in FIG. 36 illustrates the first flexible tether 3506 and the second flexible tether 3508 as timing belts, it should be understood that the attachment device 3600 can similarly be used in conjunction with other types of flexible tethers.

Attachment device 3600 includes a base portion 3602, attachment plate 3604, and fasteners (e.g., comprising bolts 3606 and nuts 3608). Attachment plate 3604 includes teeth 3610. The teeth 3610 engage with corresponding teeth of the first flexible tether 3506 and the second flexible tether 3508. In some implementations, the number of teeth of each flexible tether that engages with the teeth 3610 of the attachment plate 3604 can range between 2-12 teeth, such as between 3-9 teeth, and/or between 4-6 teeth.

Attachment device 3600 is configured to couple the first flexible tether 3506 with the second flexible tether 3508, such that, when a respective end portion of the first flexible tether 3506 and a respective end portion of the second flexible tether 3508 are attached to the attachment device 3600, the respective end portion of the first flexible tether 3506 and the respective end portion of the second flexible tether 3508 extend along a common axis that is parallel to a direction of translation of the intermediate section assembly 162. According to some examples, the first flexible tether 3506 and the second flexible tether 3508 are separated from having direct contact with one another.

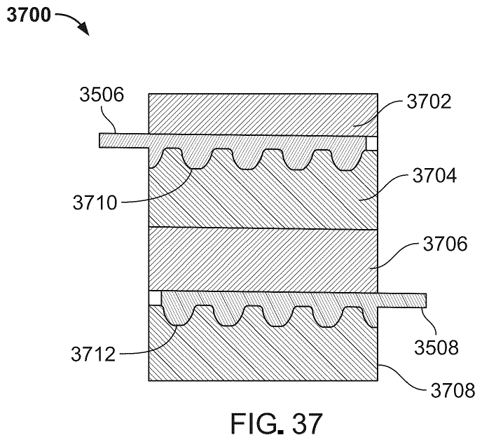

FIG. 37 illustrates a side view of another example attachment device 3700 for coupling multiple flexible tethers (e.g., the first flexible tether 3506 and the second flexible tether 3508 in FIG. 35) to a portion of a horizontal positioning system (e.g., horizontal positioning system 140) according to some implementations. Attachment device 3700 is an example of an attachment device that can be used as the first attachment device 3512 and/or the second attachment device 3510 described herein with reference to FIG. 35. While the example in FIG. 37 illustrates the first flexible tether 3506 and the second flexible tether 3508 as timing belts, it should be understood that the attachment device 3600 can similarly be used in conjunction with other types of flexible tethers.

Attachment device 3700 includes a first base portion 3702, a first attachment plate 3704, a second base portion 3706, and a second attachment plate 3708. The first flexible tether 3506 is sandwiched between the first base portion 3702 and the first attachment plate 3704. The first attachment plate 3704 includes teeth 3710 that engage with corresponding teeth of the first flexible tether 3506. The second flexible tether 3508 is sandwiched between the second base portion 3706 and the second attachment plate 3708. The second attachment plate 3708 includes teeth 3712 that engage with corresponding teeth of the second flexible tether 3508.

Attachment device 3700 is configured to couple the first flexible tether 3506 with the second flexible tether 3508, such that, when a respective end portion of the first flexible tether 3506 and a respective end portion of the second flexible tether 3508 are attached to the attachment device 3600, the respective end portion of the first flexible tether 3506 extends along a first axis that is parallel to a direction of translation of the intermediate section assembly 162, and the respective end portion of the second flexible tether 3508 extends along second axis, which is distanced from the first axis and also parallel to the direction of translation of the intermediate section assembly 162.

In the stacked arrangement shown in FIG. 37, the first flexible tether 3506 is positioned above the second flexible tether 3508. However, the second flexible tether 3508 can be positioned above the first flexible tether 3506 in other implementations.

Fasteners (not shown) can be used to attach the flexible tethers to the attachment device 3700. For example, bolts and nuts can be used as similarly described herein with reference to FIG. 37. In some implementations, a fastener may not penetrate all the way through an attachment device. For example, a fastener may only partially extend into an attachment device in some examples. Other types of fasteners (e.g., adhesives, rivets, welding, etc.) can additionally or alternatively be used in an attachment device in various implementations.

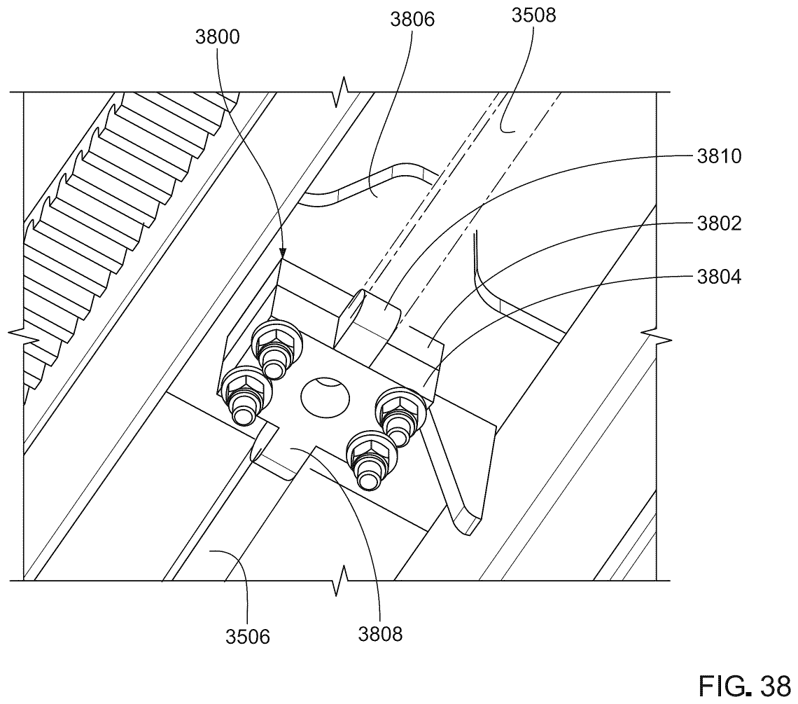

FIG. 38 illustrates a perspective view of yet another example attachment device 3800 for coupling multiple flexible tethers (e.g., the first flexible tether 3506 and the second flexible tether 3508 in FIG. 35) to a portion of a horizontal positioning system (e.g., horizontal positioning system 140) according to some implementations. Attachment device 3800 is an example of an attachment device that can be used as the first attachment device 3512 and/or the second attachment device 3510 described herein with reference to FIG. 35.

Attachment device 3800 includes a base portion 3802, attachment component 3804, and/or extension plate 3806. Attachment component 3804 includes a first attachment location 3808 to which the first flexible tether 3506 is attached, and a second attachment location 3810 to which the second flexible tether 3508 is attached. Attachment component 3804 is coupled with base portion 3802 and/or extension plate 3806 via fasteners (e.g., comprising bolts 3812, nuts 3814, and/or washers 3816). In some implementations, extension plate 3806 can extend and attach to the base section assembly 160 or the distal section assembly 164.

In some implementations, the first flexible tether 3506 and the second flexible tether 3508 are chains. However, as previously mentioned, the first flexible tether 3506 and/or the second flexible tether 3508 can be other types of flexible tethers in various embodiments.

### Refuse Container Lift Mechanism

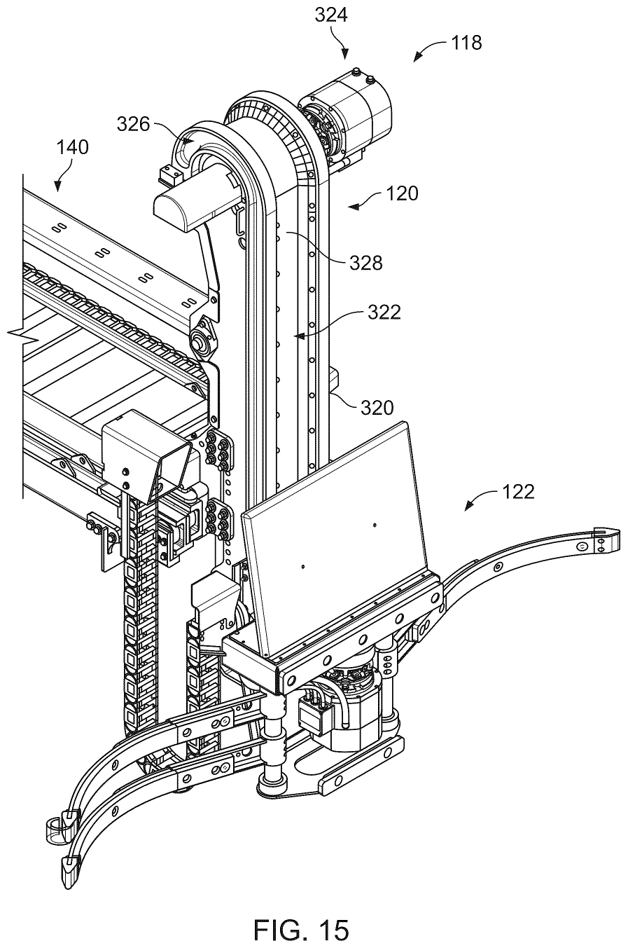

FIG. 15 is a perspective view of a refuse container emptying system according to some implementations. Refuse container emptying system 118 includes container lift mechanism 120 and grabber system 122. Grabber system 122 is coupled to container lift mechanism 120. Grabber system 122 can be operated to couple to a refuse container. Container lift mechanism 120 is bolted to distal section assembly 164 of horizontal positioning system 140. Container lift mechanism 120 can be operated to lift the refuse container and tip and dump contents of the refuse container into hopper 116 (shown in FIG. 1).

Container lift mechanism 120 includes mast 320, timing belt system 322, and vertical drive unit 324. Mast 320 includes guides 326. Timing belt system 322 includes timing belt 328. Grabber system 122 is coupled to timing belt 328. In some implementations, grabber system 122 secured to timing belt 328 by way of a belt attachment device.

Vertical drive unit 324 is coupled to timing belt system 322. Vertical drive unit 324 is operable to move timing belt 328 to raise and lower grabber system 122 on mast 320.

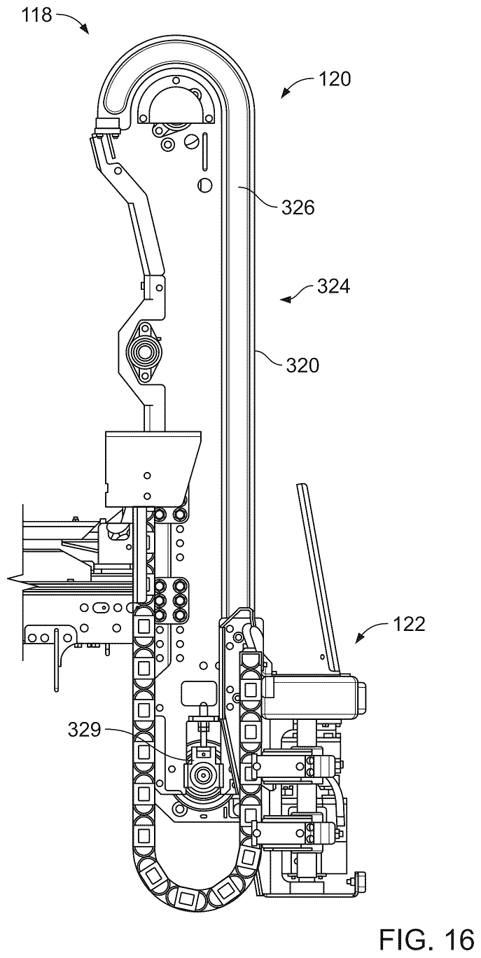

FIG. 16 is a side view of refuse container emptying system. Vertical drive unit 324 (shown in FIG. 15) is operable to raise grabber system 122. Roller assemblies on either side of the grabber system 122 roll in guides 326 of mast 320. Initially, the grabber system 122 is raised straight up as roller assemblies travel through the straight portion of guides 326. As roller assemblies on either side of grabber system 122 pass into the curved upper portion of guides 326, the refuse container held in grabber system 122 partially inverts, tipping the refuse container such that its contents are dumped into a hopper of the refuse vehicle.

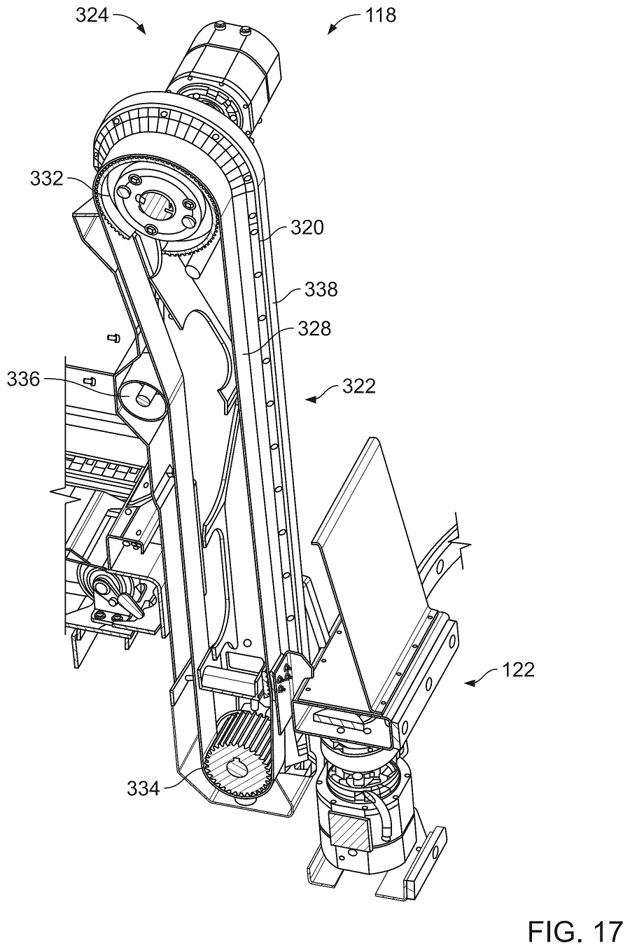

FIG. 17 is a cross sectional view illustrating a timing belt system of a container lift mechanism according to some implementations. Timing belt system 322 includes upper timing pulley 332, lower timing pulley 334, timing belt 328, and idler 336. Upper timing pulley 332 and lower timing pulley 334 are mounted between left and right main supports 338 of mast 320. Idler 338 promotes engagement of timing belt 328 with upper timing pulley 332 and lower timing pulley 334. Vertical drive unit 324 is operably connected to upper timing pulley 332. Grabber system 122 is attached to timing belt attachment device 342. Vertical drive unit 324 can be operated to turn upper timing pulley 332. The front portion of timing belt 328 can be moved up on mast 320.

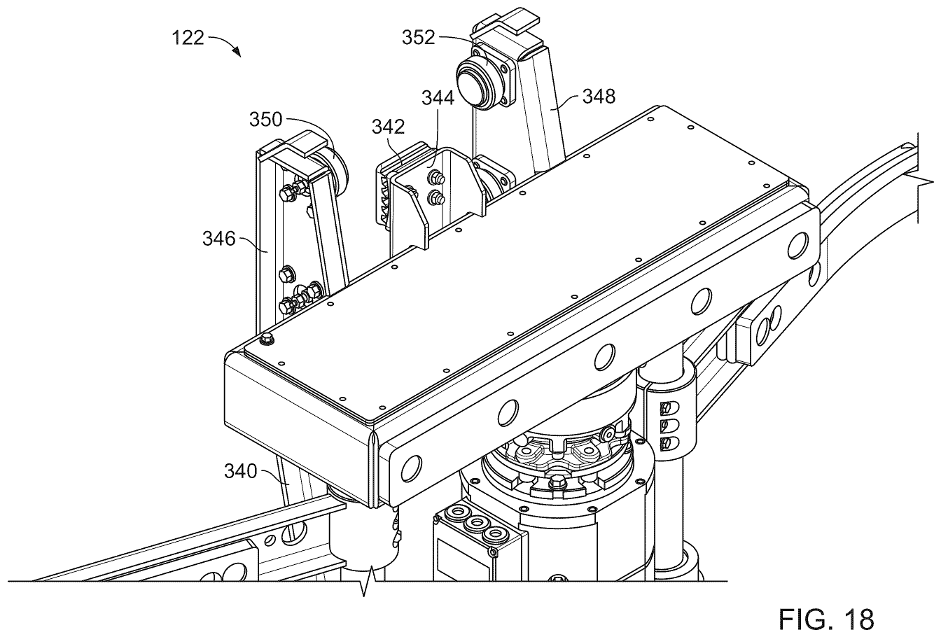

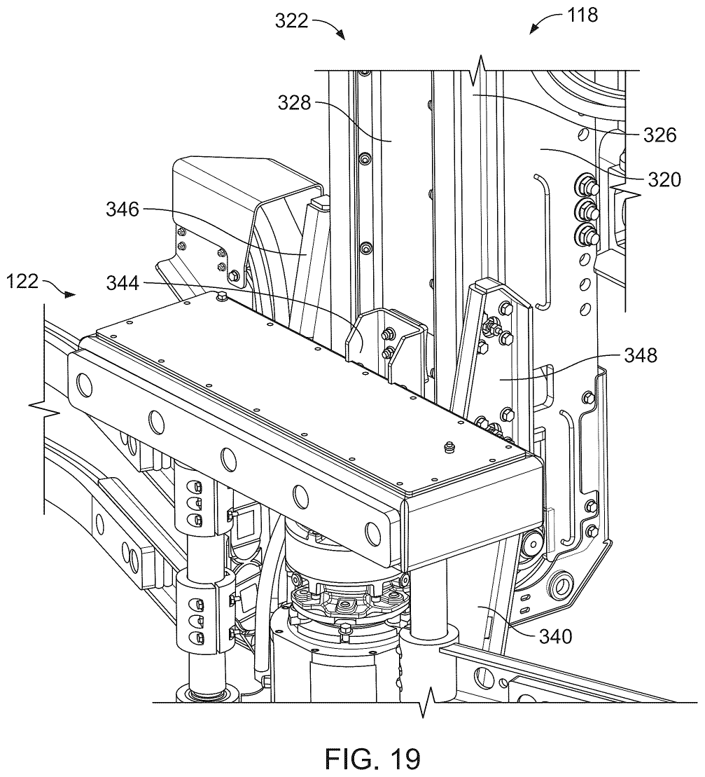

FIG. 18 is a perspective view of a grabber system. FIG. 19 illustrates a connection of a grabber system to a timing belt system of a container lift mechanism. Grabber system 122 includes body 340, timing belt attachment member 344, left roller support 346, and right roller support 348. Left double roller assembly 350 is coupled to left roller support 346. Right double roller assembly 352 is coupled to right roller support 348. Each of left double roller assembly 350 and right double roller assembly are engaged in guides 326 on either side of mast 320. Attachment device 342 couples timing belt attachment member 344 to timing belt 328, thus securing grabber system 122 to a section of timing belt 328.

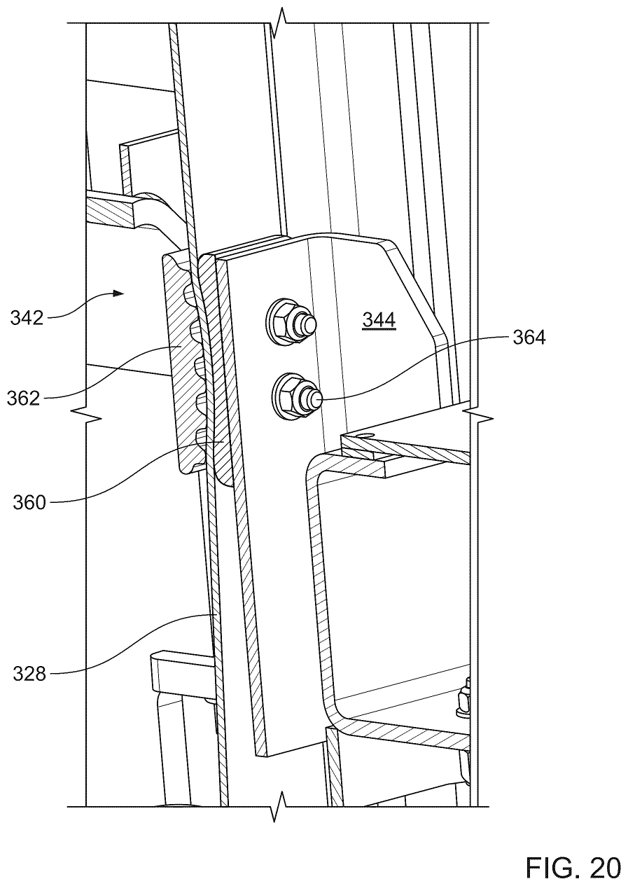

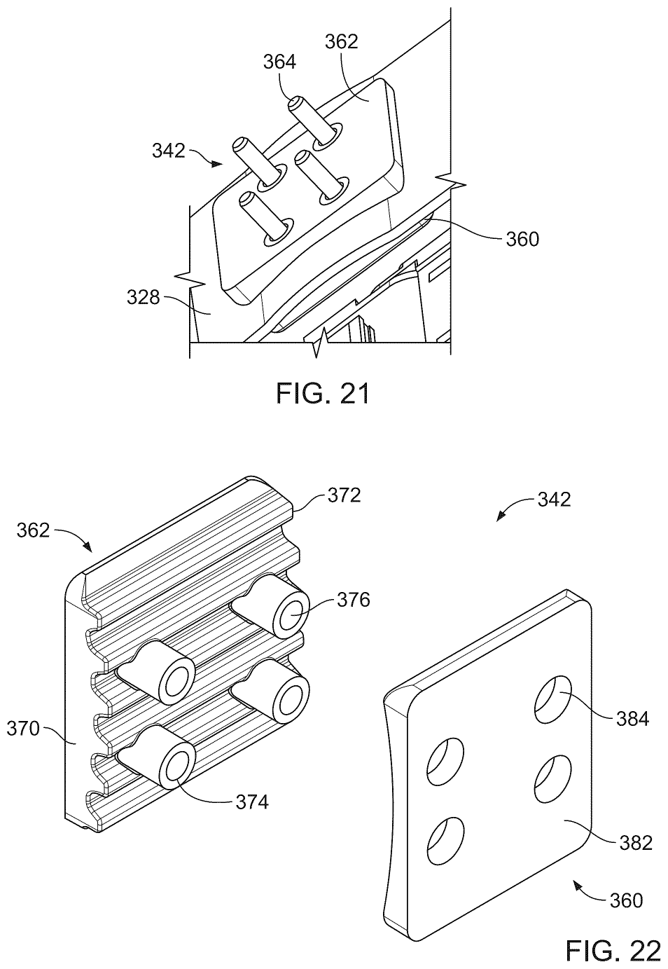

FIG. 20 is a cross sectional view illustrating a connection of a grabber system to a timing belt according to some implementations. FIG. 21 is a perspective view illustrating a belt attachment device on a timing belt. Attachment device 342 includes front plate 360 and back plate 362. Back plate 362 has teeth that correspond to teeth on the timing belt 328 (in FIG. 20, the teeth on timing belt 328 are omitted for clarity). Fasteners 364 are installed in holes in timing belt attachment member 344, front plate 360, back plate 362, timing belt attachment member 342 of grabber system 122. Fasteners 364 can be bolts with a corresponding nut.

FIG. 22 is an exploded view of an attachment device that can be used to attach a grabber system to a timing belt. Back plate 362 includes body 370, teeth 372, and bosses 374. Bosses 374 include through holes 376. Front plate 380 includes body 382 and through holes 384.

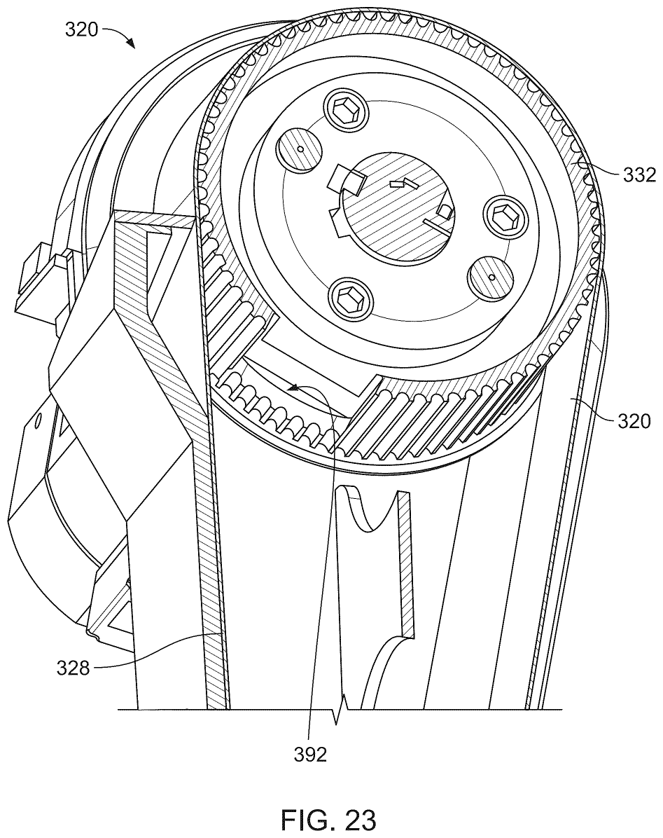

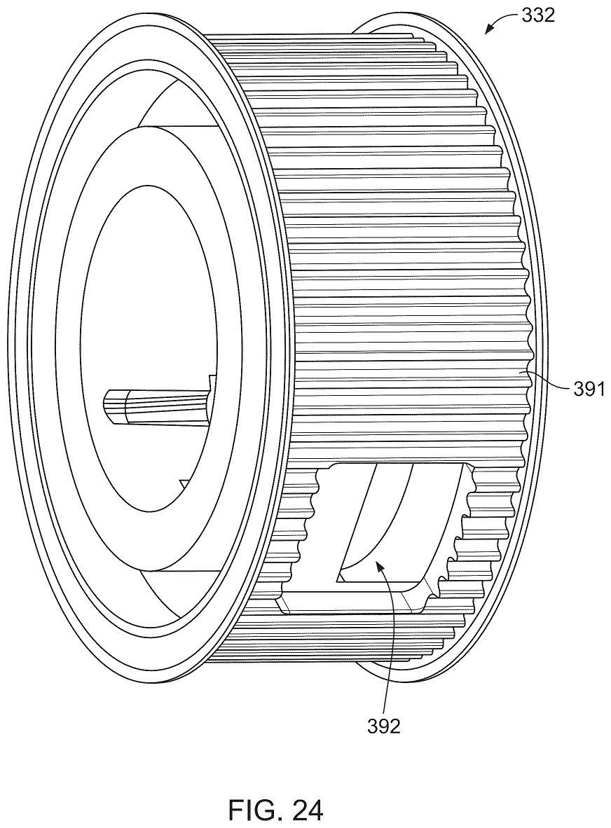

FIG. 23 illustrates an upper portion of timing belt system according to some implementations. Upper timing pulley 332 is installed on mast 320. Upper timing pulley 332 includes teeth 390 and recess 392. Recess 392 accommodates attachment device 342 (shown in FIG. 22) when grabber system 122 is raised on mast 320 to empty a refuse container. FIG. 24 illustrates upper timing pulley 332. Upper timing pulley 332 includes teeth 391 and opening 392. In the example shown in FIG. 24, recess 392 is a generally square opening that passes through the body of upper timing pulley 332. A recess can, however, have other shapes, such as circular, rectangular, or ovate. In some implementations, a timing pulley includes more than one recess.

In several of the figures included herein, a timing belt is depicted with the teeth of the timing omitted for clarity. In various implementations, however, the timing belt includes teeth that engage complementary teeth in an attachment device. Thus, for example, the teeth of the timing belt can match the pitch of the teeth of an attachment plate.

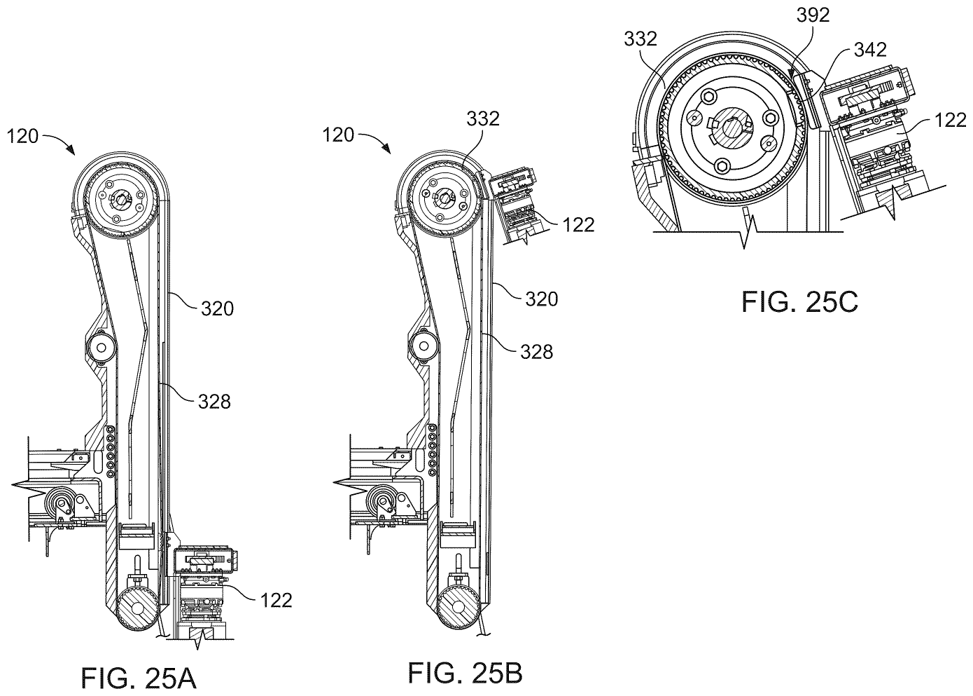

FIGS. 25A, 25B, and 25C illustrate raising of a grabber system on a refuse container lift mechanism. Initially, grabber system 122 and attachment device 342 are at the bottom of mast 320 (FIG. 25A). The vertical drive unit can be operated to move timing belt 328 such that grabber system 122 and attachment device 342 are raised on mast 320 (FIG. 25B).

The angular position of recess 392 on upper timing pulley 332 can be synchronized with the position of attachment device 342. When attachment device 342 reaches upper timing pulley 332, back plate 362 of attachment device 342 can enter recess 392 (best seen in FIG. 25C, which is a detail view of the upper portion of the FIG. 25B). In some implementations, clearance is maintained between the back plate 362 and upper timing pulley 332. In other implementations, a portion of the attachment device (e.g., back plate 362) engages in recess 392. In such cases, a portion of the load of grabber system 122 and the refuse container can be transmitted through upper timing pulley 332 to mast 320. Engagement of an attachment device with a pulley of a belt drive system may increase stability of a refuse container emptying during emptying of the refuse container into the refuse vehicle.

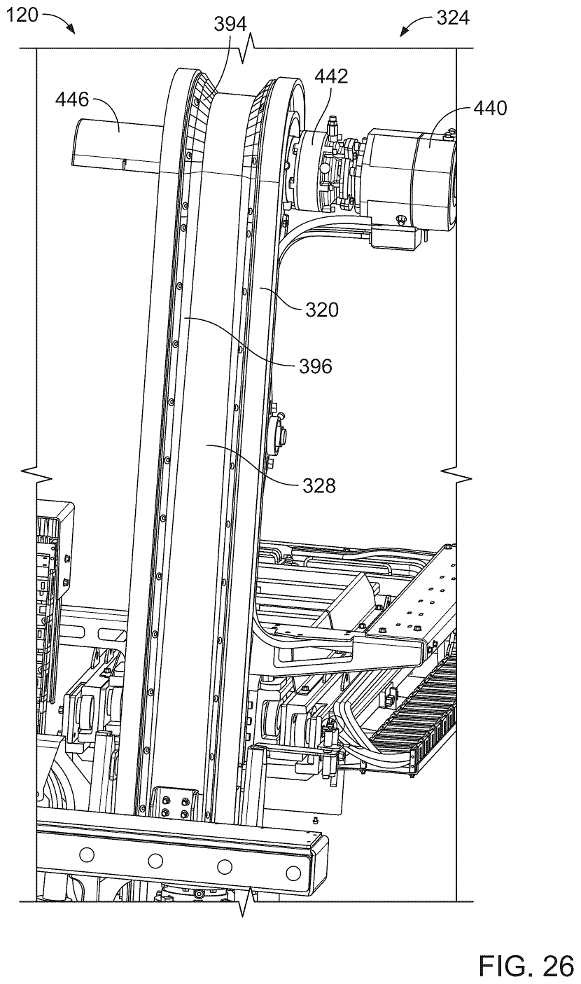

FIG. 26 is a perspective front view of a mast of a container lift mechanism. Container lift mechanism 120 includes belt guides 394 and guards 396. A belt guide is mounted to mast 320 on each side of timing belt 328. Belt guides 394 may be tapered such that the belt guides form a spaced-apart vee pattern. Belt guides 394 may help maintain help keep timing belt 328 centered as attachment device 342 is raised and lowered on mast 320.

In this example, guards 396 are provided on the left and right sides of timing belt 328. Guards 396 can be in the form of one or more strips that run along the edge of timing belt 328 from the top to bottom of mast 320. Guards 396 can be made of a resilient material, such as rubber.

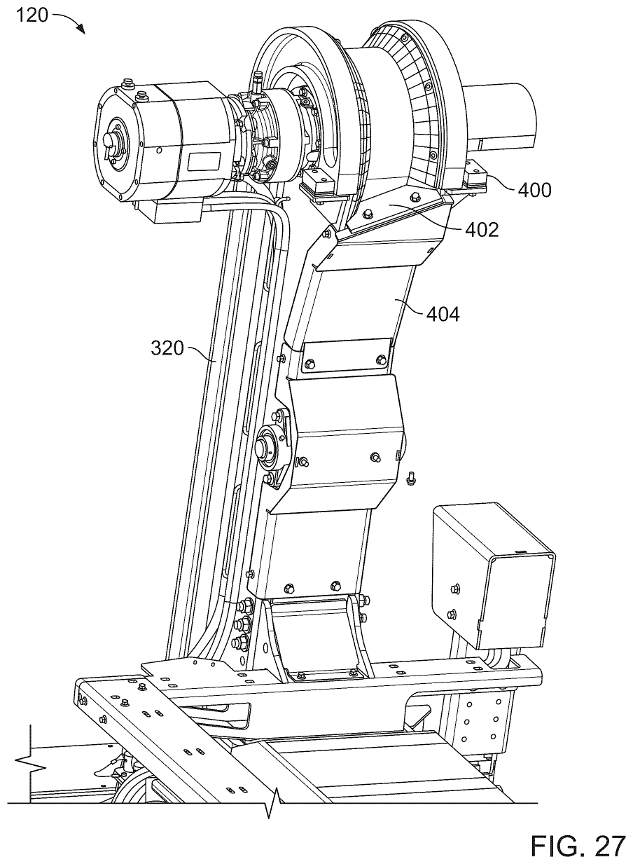

FIG. 27 is a rear perspective view of a container lift mechanism. Container lift mechanism 120 includes stops 400, scraper 402, and covers 404. Stops 400 can inhibit motion of grabber system 122 once the grabber system has been lifted over the curved portion of guides mast 320. Tensioning device 329 can be used to adjust tension of timing belt system 324.

Scraper 402 is secured to mast 320. Scraper 402 can contact the surface of timing belt 328 as timing belt 328 is moved on mast 320. Scraper 402 can remove debris from the surface of timing belt 328. Covers 404 protect the timing belt system from falling debris and contamination.

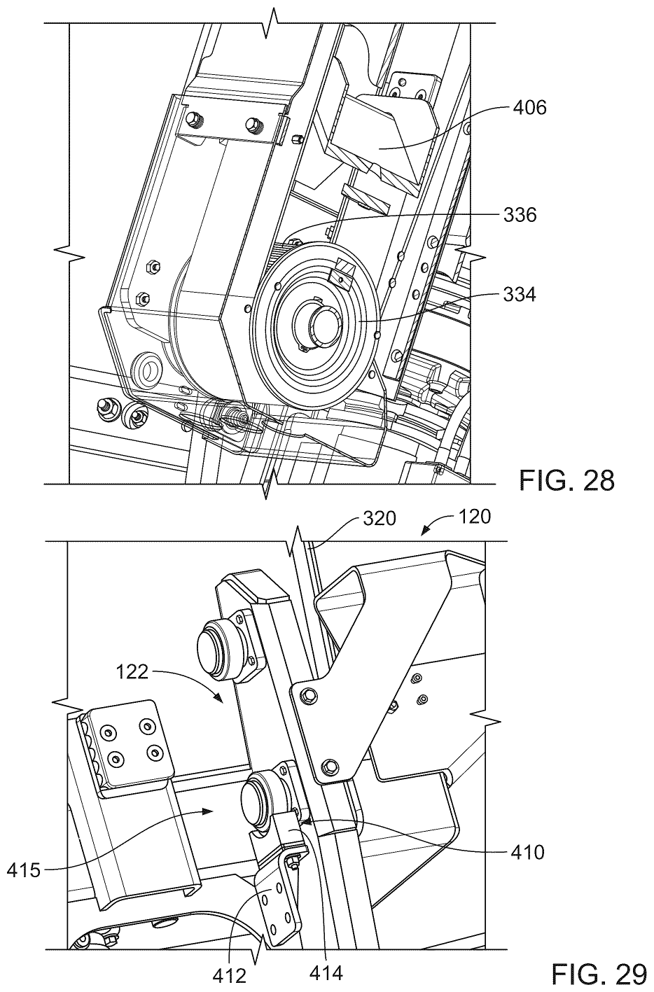

FIG. 28 is a cross sectional view showing a lower timing pulley of a container lift mechanism. Timing belt 328 moves on lower timing pulley 334. The teeth on timing belt 328 engage on teeth 336 on lower timing pulley 334. Timing belt system 330 can include a tensioning device. The tensioning device can change the position of lower timing pulley 334. In this manner, the tension of timing belt 328 can be adjusted by a user.

Container lift mechanism 120 includes lower timing pulley shield 406 installed between the front side and rear sides of timing belt 328. Lower timing pulley shield 406 protects lower timing pulley 334 from debris and contamination. Lower timing pulley shield 406 can have an inverted vee shape.

Referring again to FIG. 16, timing belt system 322 can include belt tensioning device 329.

FIG. 29 is a perspective view illustrating a bottom roller stop according to some implementations. Bottom stop 410 can be secured to mast 320. Bottom stop includes bracket 412 and stop pad 414. Stop pad 414 includes an arcuate upper surface. Bottom stop 410 can limit downward motion of grabber system 122 when grabber system is near the ground. Although only one stop is shown in FIG. 29 for illustrative purposes, a bottom stop 410 can be provided on each of the left and right sides of the container lift mechanism. Bottom stop 410 stops roller 415.

Referring again to FIG. 26, drive unit 324 includes motor 440, gearbox 442, an output shaft assembly (not shown), and encoder device 446. In the implementation shown in FIGS. 15-17, motor 440 is an electric motor. Drive unit 442 is mounted coaxially with upper timing pulley 332, near the top of mast 320. Encoder device 446 is coupled to the output shaft assembly. Encoder device 446 can sense angular position of the motor shaft. A shaft of motor 440 drives an input shaft of gearbox 442. Gearbox 442 can be coupled to the output shaft assembly. In some implementations, drive unit gearbox 442 includes a planetary gear system.

In the implementations shown above, the refuse loading system includes a motor coupled to the upper timing pulley of a container lift mechanism. In other implementations, a drive motor for a container lift mechanism can be in another location. For example, a motor can be coupled to turn the lower timing pulley of the system.

### Grabber System

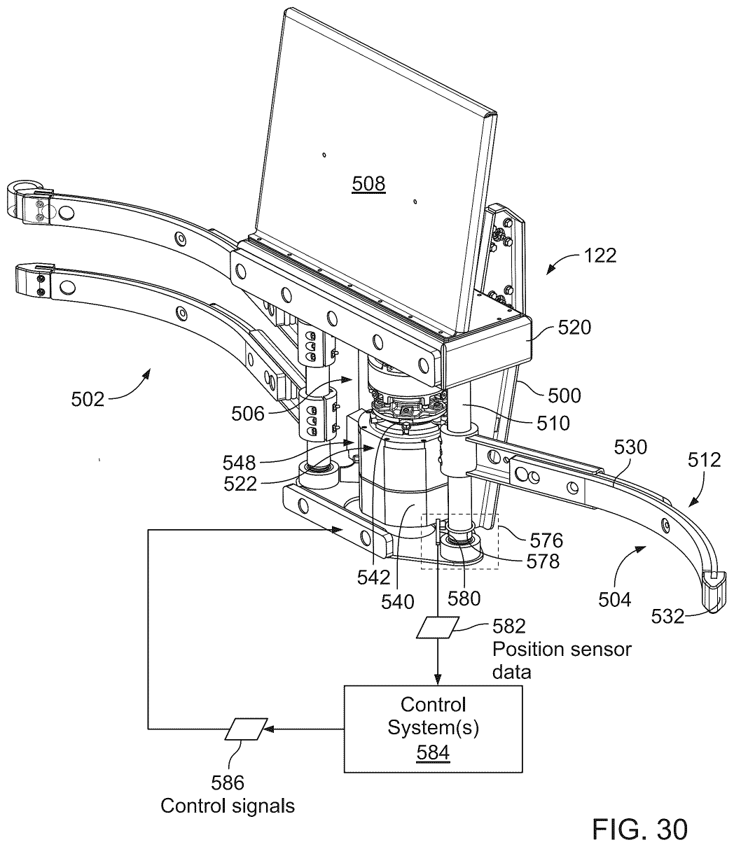

FIG. 30 is a front perspective view of a grabber system according to some implementations. Grabber system 122 includes frame 500, left arm assembly 502, right arm assembly 504, grabber drive mechanism 506, and debris shield 508. Left arm assembly 502 and right arm assembly 504 are coupled to frame 500 such that left arm assembly 502 and right arm assembly 504 can swing on frame 500 to close on a refuse container.

Left arm assembly 502 and right arm assembly 504 each include a shaft 510 and one or more arms 512. In the example shown in FIG. 30, left arm assembly 502 includes two arms 512 and right arm assembly 504 includes one arm 512. In other implementations, a grabber system includes a different number or arrangement of arms. Debris shield 508 can inhibit debris (including refuse from a refuse container) from falling into the refuse loading system during operation.

Grabber drive mechanism 506 includes grabber gearbox 520 and drive unit 522. Grabber gearbox 520 is coupled to shafts 510 of left arm assembly 502 and right arm assembly 504. Drive unit 522 is coupled to grabber gearbox 520. Drive unit 522 can be operated to move arms 510 to open and close grabber system 122 on a refuse container.

Arms 512 include body 530 and spearing tip 532. Body 530 of each arm 512 can be made of a metal, such as a spring steel. Body 530 can be resilient during use to grab a refuse container.

Each of spearing tips 532 can be removable from body 530 of arm 512. Spearing tips 532 can be made of a material that protects objects encountered by arms 512. Spearing tips can be made of a material and/or have a shape that reduces the risk of damage to refuse containers or other items that come into contact an arm 512 of the grabber system. For example, spearing tips 532 can be made of rubber. In some implementations, a spearing tip has a size and shape that reduces the width of a grabber system 122.

Drive unit 522 includes motor 540, drive unit gearbox 542, an output shaft assembly (not shown), and an encoder device (not shown). In the implementation shown in FIG. 30, motor 540 is an electric motor. Drive unit 522 is mounted below grabber gearbox 520. The encoder device 546 can be coupled to the output shaft assembly. The encoder device can sense angular position of the motor shaft. A shaft of motor 540 drives an input shaft of drive unit gearbox 542. Grabber gearbox 520 can be coupled to the output shaft assembly. In some implementations, drive unit gearbox 542 includes a planetary gear system.

Grabber drive mechanism 506 includes braking device 548. In some implementations, braking device 548 is operable by a control system to closure of grabber system 122. For example, braking device can be used to maintain a predetermined amount of gripping force on a refuse container.

According to various implementations, grabber system 122 includes one or more position sensors 576. In FIG. 30, the position sensor(s) 576 include an encoder system (e.g., a non-contact magnetic rotary encoder system) configured to sense an angular position of one or more of the grabber arms 512. In this example, the encoder system includes a magnetized component (e.g., magnetized ring 578) and a magnetic sensor (e.g., readhead 580). Magnetized ring 578 is coupled with a shaft 510, e.g., such that the magnetized ring 578 rotates together with the shaft 510. Readhead 580 is mounted on the grabber system 122 proximate the magnetized ring 578, such that the readhead 580 is capable of sensing changes in the magnetic field of the magnetized ring 578 as the shaft 510 rotates.

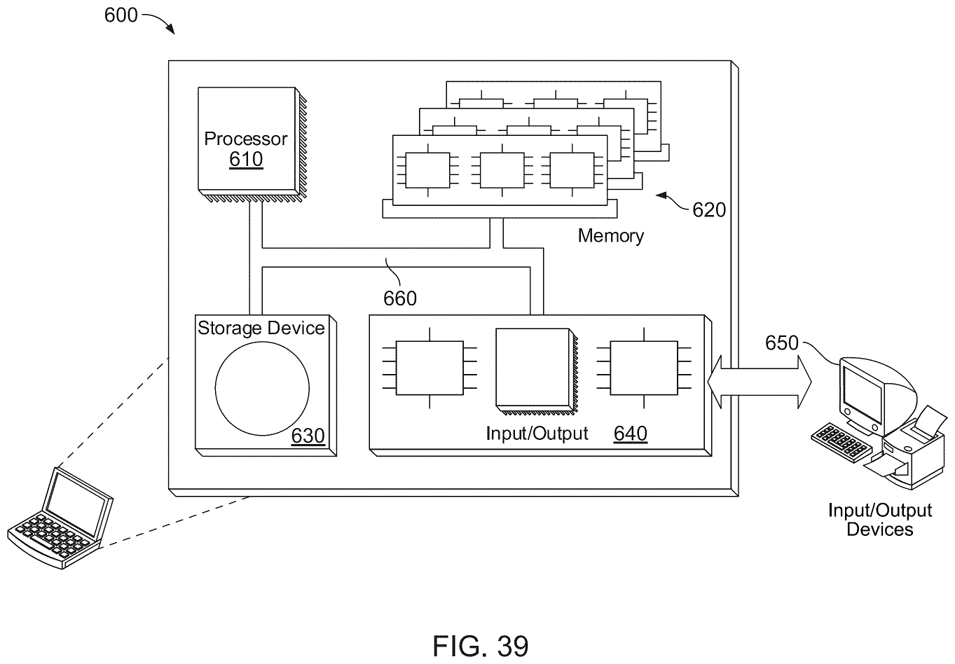

Position sensor data 582 based on the output from the readhead 580 is transmitted to one or more control systems 584 (e.g., comprising one or more computing systems, such as example computing system 600 described herein with reference to FIG. 39). Control system(s) 584 determine, based at least in part on the position sensor data 582, an angular position of one or more of the grabber arms 512.

In some implementations, control system(s) 584 determine if the angular position of the grabber arm(s) 512 requires adjustment. Based on such a determination, control system(s) 584 may transmit control signals 586 to the grabber system 122 (e.g., to drive unit 522) to control movement of the grabber arms 512. For example, control system(s) 584 can transmit control signals 586 corresponding to an adjustment in positioning of the grabber arms 512 from a current angular position to a target angular position. In various examples, the adjustment in positioning can be associated with closing the grabber arms 512 (e.g., to grab a refuse container) or opening the grabber arms 512 (e.g., to release a refuse container).

In some implementations, the readhead 580 produces an analog output (e.g., voltage or current), and the analog output is converted to a digital output. For example, control system(s) 584 can include an analog-to-digital converter (ADC) (not shown) to convert the analog output to digital output. In other implementations, a separate ADC (not included in the control system(s) 584) can convert the analog output to digital output prior to transmission of the position sensor data 582 to control system(s) 584. Position sensor data 582 can include the analog output, the digital output, or both. In various examples, the analog output is converted to digital output according to a particular standard and/or communication protocol (e.g., the J1939 standard/communication protocol).

In some implementations, the magnetic rotary encoder system can be an incremental magnetic encoder system. In other implementations, the magnetic rotary encoder system can be an absolute magnetic encoder system. In a non-limiting example, an absolute magnetic encoder system may be used to determine an absolute angular position, where a 0 volt output corresponds to 0 degrees, a 10 volt output corresponds to 360 degrees, and absolute angular positions between 0 degrees and 360 degrees can be interpolated based on voltage outputs between 0 volts and 10 volts.

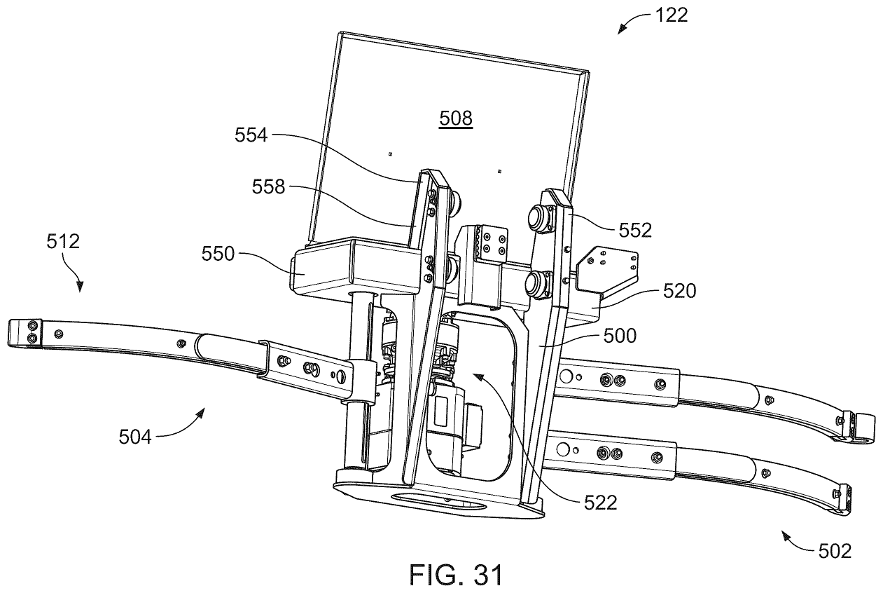

The magnetic rotary encoder system can be positioned differently than that shown in FIG. 30. For example, the magnetic rotary encoder system can be positioned at a different location along the length of the shaft 510. One or more magnetic rotary encoders can be coupled with either or both of the shafts 510. FIG. 31 is a rear perspective view of the grabber system shown in FIG. 30. In this implementation, a housing 550 for grabber gearbox 520 is integral to frame 500. Left support member 552 and right support member 554 extend vertically between grabber gearbox housing 550 and base member 556. Left support member 552 and right support member 554 each include ribs 558.

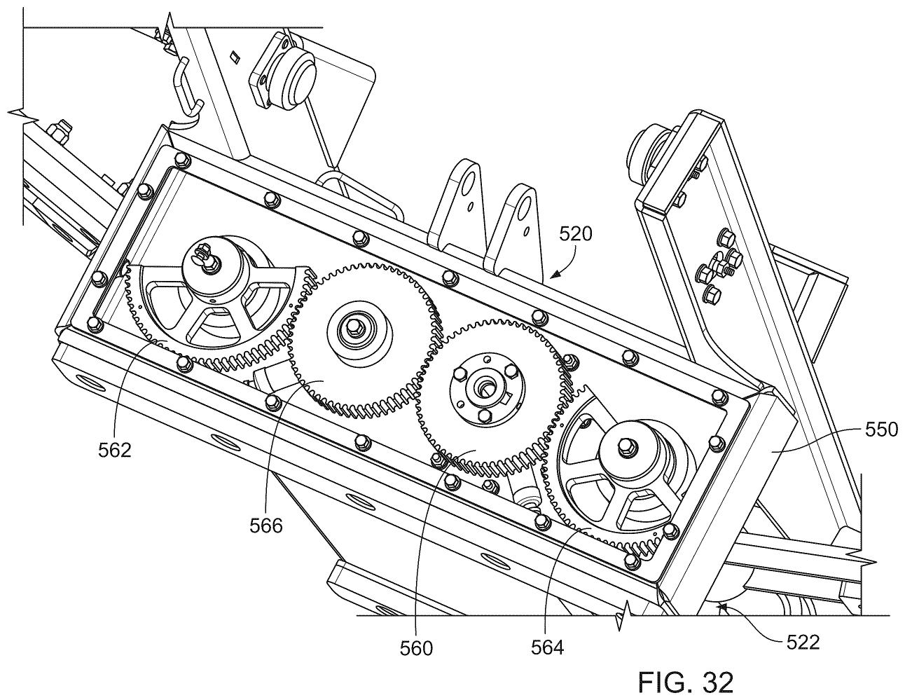

FIG. 32 illustrates a grabber gearbox with a top cover omitted for illustrative purposes. Grabber gearbox 520 includes drive gear 560, left driven gear 562, right driven gear 564, and idler gear 566. In some implementations, drive gear 560, left driven gear 562, right driven gear 564, and idler gear 566 all be co-planar with one another. Drive gear 560 is coupled to the output shaft of drive unit gearbox 542. Idler gear 566 is coupled to rotate on housing 548. Left driven gear 562 is coupled to the shaft 510 of left arm assembly 502. Right driven gear 564 is coupled to the shaft 510 of right arm assembly 504.

Idler gear 566 is operably coupled between drive gear 560 and left driven gear 562, such that left driven gear 562 rotates in the same direction as drive gear 560. When drive gear 560 is turned by drive unit 522 in a counterclockwise direction, left arm assembly 502 and right arm assembly 504 close together with one another. When drive gear 560 is turned by drive unit 522 in a clockwise direction, left arm assembly 502 and right arm assembly 504 spread apart from one another.

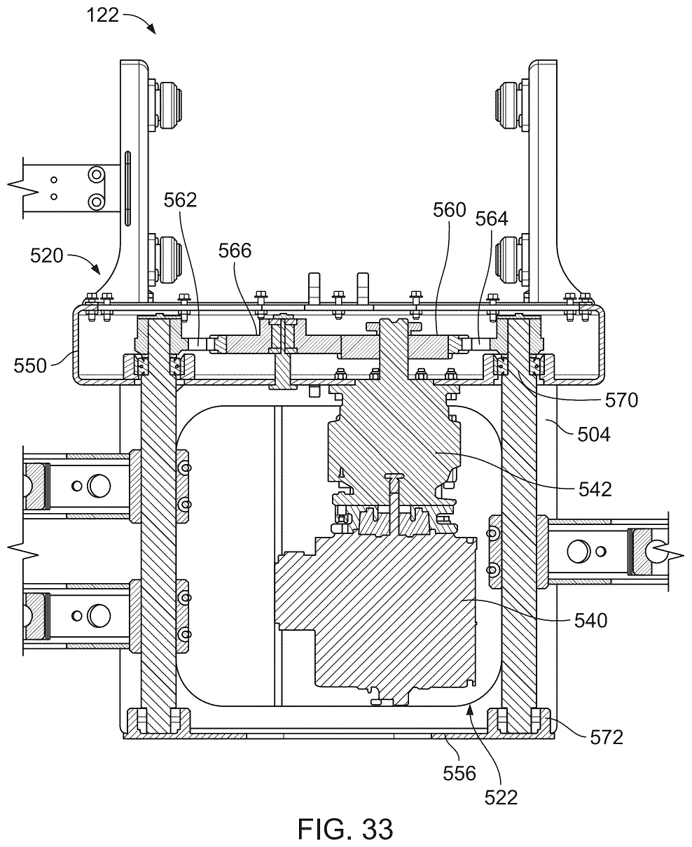

FIG. 33 is a partial cross-sectional view of a grabber system according to some implementations. Grabber gearbox 522 includes drive gear 560, left driven gear 562, right driven gear 564, and idler gear 566. In this example, drive gear 560, left driven gear 562, right driven gear 564, and idler gear 566 are all be co-planar with one another. Drive unit 522 is mounted to grabber gearbox housing 550 below the grabber gearbox housing and between the shafts of left arm assembly 502 and right arm assembly 504.

Grabber gearbox housing 550 includes upper bearings 570. Base member 556 includes lower bearings 572. Upper bearings 570 and lower bearings 572 facilitate rotation of left arm assembly 502 and right arm assembly 504.

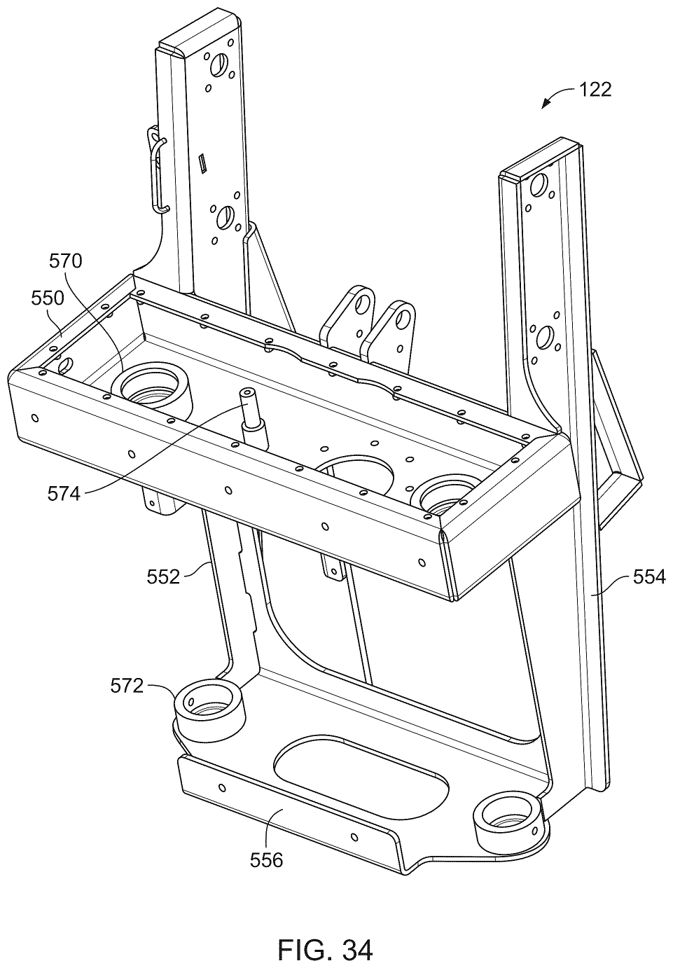

FIG. 34 is a perspective view of a frame for a grabber system. In one implementation, left support member 552, right support member 554, and base member 556 are formed from sheet metal. Grabber gearbox housing 550 can be attached (e.g., by welding) to left support member 552 and right support member 554. Idler gear shaft 574 is provided on the bottom panel of grabber gearbox housing 550.

Any or all of the horizontal position system, the container lift mechanism, and the grabber system can include a braking device. A braking device can be operably coupled to a controller. In some implementations, the braking device is included is a motor braking device. In other implementations, the braking device is separate from the motor (for example, a brake that engages a rail of distal section to arrest motion of the distal section).

In some implementations, braking device is used to maintain operating characteristics of a refuse loading component. For example, a braking device can be used to maintain closing force on grabber system during operation. In some implementations, a braking device is used to maintain a component of a mechanism is a desired position while the component is not in use. For example, a braking device can be used to maintain the arms of a grabber in a fixed position on the refuse vehicle while the refuse vehicle is between stops.

In various implementations, the brake assembly can be on the gear components, a motor brake (electronic braking), within the planetary gearbox, or on a rotating component (such as the output shaft of the motor, or one of the pivot shafts). The brake can be electromechanical (e.g. a clutch pack or actuator to create friction between a movable part and relatively stationary part, etc.), or mechanical (e.g. interference pin, dog engagement, etc.).

Sensors can be included on various components of a refuse loading system, including, for example, a grabber device. A refuse loading system can include other sensors. For example, a refuse loading system can include load sensors, proximity switches, position sensors, angle sensors, or pressure sensors. Operation of the refuse loading mechanism or other systems can be controlled based on the information provided by the sensors. In some implementations, a refuse collection system includes sensors to sense position, angle, load or other characteristics about the system. As an example, a sensor can sense position of component of a horizontal positioning system (e.g., a distal section or an intermediate section). As another example, a sensor can sense position of a grabber system on a container lift mechanism. As another example, a grabber system can include a proximity switch that senses the position of an arm of a grabber or a refuse container.

Control of a refuse collection device may be carried out manually, automatically, or a combination thereof. In some implementations, a control system collects data from refuse collection system sensors and/or other operational sensors and controls the refuse collection system or other components of vehicle based on the information. For example, a control system may automatically shut down or reduce the speed of a drive system if a load (or another measured characteristic of the refuse vehicle's system) is outside an established range or exceeds an established threshold.

In some implementations, torque, speed, or other parameters are adjusted based on the position, load, or other characteristics of one or more members of a refuse loading mechanism. For example, in certain implementations, the torque of the motor, energy consumption, or other operating parameters are adjusted to account for different loads. Operation of loading mechanism for collecting recycled material can, for example, be different than operation of the loading mechanism for collecting trash. In some implementations, the rate of motion of the reciprocating member can be controlled. In some implementations, a system includes interlocks to prevent unintended or un-commanded movement.

In some implementations, the control system receives position feedback from motor movement (e.g., using a sensored motor in time with the belt, position of in/out or up/down can be determined mathematically from rotation/partial rotation of motor and belt pitch).

In some implementations, belt slip is monitored. In one example, belt slip is monitored using end-of-travel position/sensors.

In various implementations described above, devices are powered electrically. In certain implementations, however, devices used to operate components of a mechanism a refuse loading mechanism (such as a grabber device lift arm, or a reciprocating member) can be activated or powered in other manners, such as pneumatically, mechanically, or hydraulically.

Control units and/or computing devices as described herein can include or use one or more computing systems. FIG. 39 depicts an example computing system, according to implementations of the present disclosure. The system 600 may be used for any of the operations described with respect to the various implementations discussed herein. The system 600 may include one or more processors 610, a memory 620, one or more storage devices 630, and one or more input/output (I/O) devices 650 controllable via one or more I/O interfaces 640. The various components 610, 620, 630, 640, or 650 may be interconnected via at least one system bus 660, which may enable the transfer of data between the various modules and components of the system 600. In some implementations, a control system may be coupled to an operator display and control panel (for example, located in a cab of the vehicle.)

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs). The system 600 may include one or more I/O devices 650.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

In various implementations described above, a system includes a timing pulley that is coupled to the output shaft of a motor. A refuse loading system can, in other implementations, include other drive unit arrangements that turn to drive element of the system. In some implementations, a drive unit of the packing device includes an outrunner/hub motor arrangement. In this implementation, the rotor of the electric motor is positioned outside the stator. In some implementations, a shell of an outrunner motor as includes teeth, grooves, or other features on the outer surface of the shell that directly engage on a belt. In this case, a separate timing pulley can be omitted.

Implementations may be employed with respect to any suitable type of RCV, with any suitable type of body and/or hopper variants. For example, the RCV may be an automated side loader vehicle, such as described above relative to FIGS. 1 and 2. As another example, the RCV can be a commercial front loader (e.g., for dumpster type containers.) As another example, the RCV can be a residential front loader. A front loader can be provided with or without an intermediate collection device. The intermediate collection device can be used, for example, to collect residential-sized containers. In other implementations, the refuse vehicle may be a front-loading truck, a rear loading truck, a roll off truck, or some other type of garbage collection vehicle.

In some implementations described above, a timing belt in a refuse loading system as described herein is made of a polycarbonate material. In some implementations, the timing belt has a 14 mm pitch.

In various implementations described above, a refuse loading system includes timing belt drive systems. A refuse loading system can, however, in some implementations, include other types of belt systems. In addition, a refuse loading system can, in some implementations, include other types of drive mechanisms, such as a chain drive, a hydraulic drive, a direct drive, or a linear motor.

As used herein, a “drive unit” includes any device, mechanism, or system that imparts force to mechanically drive one or more components. Examples of a drive unit include a hydraulic motor, an electric motor, or an engine. A driver may also include gearboxes, belts, chain drives, or other power transmission devices.

In addition to the implementations of the attached claims and the implementations described above, the following numbered implementations are also innovative.

In a general aspect of the disclosure, a system for loading refuse includes a grabber system and a container lift mechanism. The grabber system is operable to engage a refuse container. The container lift mechanism is configured to couple between the grabber system and a refuse collection vehicle and is operable to lift a refuse container held by the grabber system to empty contents of the refuse container into the refuse collection vehicle. The container lift mechanism includes a mast, a timing belt system, a belt attachment device, and one or more vertical drive units. The mast includes one or more vertical rails, at least one of the vertical rails including one or more guides is configured to guide the grabber system on the mast. The timing belt system includes a pair of timing pulleys and a timing belt. The pair of timing pulleys are spaced vertically from one another and each is rotatably coupled to the mast. The pair of timing pulleys includes an upper timing pulley and a lower timing pulley. The timing belt is coupled around the pair of timing pulleys. The belt attachment device is configured to couple the grabber system to the timing belt. The one or more vertical drive units are configured to rotate at least one of the timing pulleys such that the timing belt pulls the grabber system up the mast.

In some implementations, at least one of the one or more guides includes an arcuate guide portion configured to tip the refuse container as the grabber system is raised to empty contents of the refuse container into a receptacle of the refuse collection vehicle.

In some implementations, the system includes one or more roller assemblies. At least one of the one or more roller assemblies includes one or more rollers configured to roll along at least one of the one or more guides.

In some implementations, at least one of the roller assemblies includes a pair of in-line rollers configured to sequentially roll along at least a portion of at least one guide.

In some implementations, at least one of the roller assemblies is configured to move along an arcuate portion of at least one guide such that a refuse container coupled to the grabber system is tipped to empty contents of the refuse container into the refuse collection vehicle.

In some implementations, the belt attachment device is configured travel around at least a portion of the upper timing pulley.

In some implementations, the upper timing pulley defines a recess configured to receive at least a portion of the belt attachment device as the attachment device travels around at least a portion of the upper timing pulley.

In some implementations, the recess includes a gap in a series of teeth in the upper timing pulley.

In some implementations, the timing belt system is configured such that at least a portion of the belt attachment device moves in a path tangential to the upper timing pulley as the belt attachment device travels around the upper timing pulley.

In some implementations, the belt system is configured such that at least a portion of the timing belt between the upper timing pulley and the lower timing pulley is non-linear when the grabber system is in a bottom position on the container lift mechanism.

In some implementations, at least one of the vertical drive units includes an electric motor.

In some implementations, at least one of the belt attachment devices includes an attachment block including two or more teeth configured to engage with two or more complementary teeth of one of the timing belts.

In some implementations, the belt attachment device includes a pair of attachment blocks. A first one of the attachment blocks is coupled on the inside of the timing belt. A second one of the attachment blocks is coupled of the outside of the timing belt.

In some implementations, the belt attachment device includes a pair of attachment blocks. At least one of the attachment blocks includes two or more teeth configured to engage complementary teeth on the timing belt.

In some implementations, the belt attachment device includes two or more fasteners configured to secure a section the timing belt to the belt attachment device.

In some implementations, the belt attachment device includes one or more fasteners configured to pass through the timing belt.

In some implementations, at least one of the vertical drive units includes a direct drive coupled to the upper timing pulley.

In some implementations, the grabber system includes a grabber system drive unit operable to engage a pair of opposing arms with the refuse container.

In some implementations, the grabber system drive unit includes an electric motor.

In some implementations, the system includes one or more debris shields configured to inhibit debris from entering an interior of the timing belt system.

In some implementations, at least one of the debris shields is configured to contact a surface of the timing belt while the timing belt is moving.

In some implementations, the system includes one or more scraping members configured to contact an exterior surface of the timing belt and scrape material from the exterior surface.

In some implementations, at least one of the scraping members is on a back-side of the timing belt.

In some implementations, the system includes one or more tensioning devices configurable to adjust tension in the timing belt.

In some implementations, the system includes one or more idlers configured to contact an exterior surface of the timing belt.

In some implementations, at least one of the belt attachment devices includes an attachment block including two or more teeth configured to engage with two or more complementary teeth of one of the timing belts.

In a general aspect of the disclosure, a method of loading refuse includes rotating a drive pulley engaged with a timing belt to lift a refuse loading system coupled to a section of the timing belt; and operating the refuse loading system to load refuse into a refuse collection vehicle.

In some implementations, operating the refuse loading system includes raising a refuse container up a mast of the refuse loading system.

In some implementations, operating the refuse loading system to load refuse into a refuse collection vehicle includes lifting a grabber system engaged with a refuse container.

In some implementations, the method includes, before rotating the drive pulley, clamping the section of the timing belt to couple the grabber system to the section of the timing belt.

In some implementations, operating the refuse loading system includes tipping the refuse container such that contents of the refuse container are emptied into a receptacle of the refuse collection vehicle.

In some implementations, operating the refuse loading system includes moving a set of rollers through an arcuate guide such that a refuse container is tipped to empty contents of the refuse container into a refuse collection vehicle.

In some implementations, operating the refuse loading system includes moving a belt attachment device around at least a portion of an upper drive pulley.

In some implementations, the method includes, before rotating the drive pulley, arranging the timing belt to synchronize a position of the belt attachment device relative to a recess in the upper timing pulley.

In some implementations, the method includes scraping a surface of the timing belt to inhibit contamination of a timing belt system.

In some implementations, rotating the drive pulley engaged with the timing belt includes operating an electric motor.

In a general aspect of the disclosure, a system for loading refuse includes a grabber system and a container lift mechanism. The grabber system is operable to engage a refuse container. The container lift mechanism is configured to couple between the grabber system and a refuse collection vehicle and operable to lift a refuse container held by the grabber system to empty contents of the refuse container into the refuse collection vehicle. The container lift mechanism includes a mast and one or more vertical drive units. The mast includes one or more vertical rails. At least one of the vertical rails including one or more guides configured to guide the grabber system on the mast. The one or more vertical drive units are configured to raise the grabber system from a bottom position on the mast to a top position on the mast.

In some implementations, at least one of the one or more guides includes an arcuate guide portion configured to tip the refuse container as the grabber system is raised to empty contents of the refuse container into a receptacle of the refuse collection vehicle.

In some implementations, the system includes one or more rotating elements rotatably coupled to mast and vertically spaced from one another on the mast, the one or more rotating elements including an upper rotating element, and a lower rotating element, and a flexible member coupled around the rotating elements. At least one of the vertical drive units is operable to turn at least one of the rotating elements such that a refuse container held by the grabber system is lifted on the mast.

In some implementations, at least one of the vertical drive units includes an electric motor is operable to turn an upper rotating element.

In a general aspect of the disclosure, a system for loading refuse includes a grabber system and a container lift mechanism. The grabber system is operable to engage a refuse container. The container lift mechanism is operable to lift a refuse container held by the grabber system to empty contents of the refuse container into a refuse collection vehicle. The container lift mechanism includes a mast, a timing belt system, a belt attachment device, and one or more vertical drive units. The mast includes one or more vertical rails. The timing belt system includes a pair of timing pulleys and a timing belt. The pair of timing pulleys are spaced vertically from one another and each is rotatably coupled to the mast. The pair of timing pulleys includes an upper timing pulley a lower timing pulley. The timing belt is coupled around the pair of timing pulleys. The belt attachment device is configured to couple the grabber system to the timing belt. The belt attachment device is configured to travel around at least a portion of the upper timing pulley. The one or more vertical drive units configured to rotate at least one of the timing pulleys such that the timing belt pulls the grabber system up the mast.

In a general aspect of the disclosure, a grabber system for loading refuse includes a frame, a first arm assembly, and second arm assembly, and a grabber drive mechanism. The first arm assembly pivotally coupled to the frame. The second arm assembly is pivotally coupled to the frame. The grabber drive mechanism is coupled to the frame and operable to move the first arm assembly and the second arm assembly between an open position and a closed position to grab a refuse container. The grabber drive mechanism includes a driving gear, a first driven gear coupled to the first arm assembly and engaged with the driving gear, a second driven gear coupled to the second arm assembly, an idler gear engaged between the second driven gear and the driving gear, and a drive unit configured to rotate the driving gear.

In some implementations, the drive unit includes one or more electric motors, and a gearbox coupled between at least one of the one or more electric motors and the driving gear.

In some implementations, at least a portion of at least one of the one or more electric motors and at least a portion of the gearbox is below the driving gear.

In some implementations, at least a portion of at least one of the one or more electric motors and at least a portion of the gearbox is between the first arm assembly and the second arm assembly.

In some implementations, the driving gear, the first driven gear, and the second driven gear each include a rotation axis. The rotation axes of the driving gear, the first driven gear and the second driven gear are parallel to one another.

In some implementations, the drive unit includes a rotation axis that is parallel to a rotation axis of the driving gear.

In some implementations, the drive unit includes a motor rotation axis that is parallel to a rotation axis of the driving gear.

In some implementations, the grabber drive unit rotation axis is coaxial with a rotation axis of the driving gear.

In some implementations, the frame includes a frame body and a base extending outwardly from the frame body and configured to receive a bottom pivot element of the first arm assembly and a bottom pivot element of the second arm assembly.

In some implementations, the frame includes a frame body, a left rail extending upwardly from the frame body and configured to couple with a mast of a container lift mechanism, and a right rail extending upwardly from the frame body and configured to couple with the mast of the container lift mechanism.

In some implementations, the grabber system includes a belt-mounting portion configured to couple with a belt of a container lift mechanism.

In some implementations, the grabber system includes one or more roller assemblies. At least one of the one or more roller assemblies includes one or more rollers configured to roll along one or more guides of a container lift mechanism.

In a general aspect of the disclosure, a system for loading refuse includes a grabber system and a container lift mechanism. The grabber system includes a frame, a first arm assembly pivotally coupled to the frame, a second arm assembly pivotally coupled to the frame, and a grabber drive mechanism. The grabber drive mechanism is coupled to the frame and operable to move the first arm assembly and the second arm assembly between an open position and a closed position to grab a refuse container. The grabber drive mechanism includes a driving gear, a first driven gear coupled to the first arm assembly and engaged with the driving gear, a second driven gear coupled to the second arm assembly, an idler gear engaged between the second driven gear and the driving gear. A drive unit is configured to rotate the driving gear. The drive unit includes a motor. The container lift mechanism is configured to configured to couple between the grabber system and a refuse collection vehicle and operable to lift a refuse container held by the grabber system to empty contents of the refuse container into the refuse collection vehicle.

In some implementations, the grabber system further includes one or more roller assemblies. At least one of the one or more roller assemblies includes one or more rollers configured to roll along one or more guides of the container lift mechanism.

In some implementations, the drive unit includes one or more electric motors.

In some implementations, the container lift mechanism includes one or more electric motors.

In some implementations, the container lift mechanism includes one or more timing belt systems configured to raise the grabber system up a mast of the container lift mechanism.

In some implementations, a horizontal positioning system is configured to position the grabber system relative to the refuse collection vehicle.

In some implementations, the horizontal positioning system includes one or more electric motors.

In some implementations, the grabber system further includes a deflector coupled to the frame and configured to inhibit contents from the refuse container from falling into the system when contents of the refuse container are emptied into the refuse collection vehicle.

In a general aspect of the disclosure, a method of grabbing a refuse container includes rotating a driving gear to turn a first driven gear engaged directly with the driving gear; and a second driven gear engaged with the driving gear by way of an idler gear, such that the first driven gear and the second driven gear each rotate a pair of opposing arms to close the arms on the refuse container; and lifting the refuse container while the refuse container is held between the arms.

In a general aspect of the disclosure, a grabber system for loading refuse includes a frame, a first arm assembly, a second arm assembly and a grabber mechanism. The first arm assembly pivotally coupled to the frame. The second arm assembly is pivotally coupled to the frame. The grabber drive mechanism is coupled to the frame and operable to move the first arm assembly and the second arm assembly between an open position and a closed position to grab a refuse container. The grabber drive mechanism includes a grabber gearbox and a drive unit. The grabber gearbox includes a driving gear, a first driven gear coupled to the first arm assembly and engaged with the driving gear, and a second driven gear coupled to the second arm assembly. The drive unit is coupled to the driving gear and includes an electric motor and a drive unit gearbox. At least portion of the drive unit is below the grabber gearbox.

In some implementations, the grabber system includes a pad coupled to the frame and configured to contact the refuse container between the first arm assembly and the second arm assembly. The drive unit is at least partially behind the pad.

In some implementations, the grabber system includes an idler gear engaged between the driving gear and one of the driven gears.

In some implementations, the grabber gearbox includes a housing enclosing the driving gear, the first driven gear, and the second driven gear.

In some implementations, the grabber gearbox includes a housing and cover coupled to the housing. The cover is removable to access at least one of the driving gear, the first driven gear, and the second driven gear.

In a general aspect of the disclosure, a grabber system for loading refuse includes a frame, a first arm assembly, a second arm assembly, a grabber mechanism, and a braking device. The first arm assembly is pivotally coupled to the frame. The second arm assembly is pivotally coupled to the frame. The grabber drive mechanism is coupled to the frame and operable to move the first arm assembly and the second arm assembly between an open position and a closed position to grab a refuse container. The grabber drive mechanism includes a grabber gearbox and a drive unit. The grabber gearbox includes a driving gear, a first driven gear coupled to the first arm assembly and engaged with the driving gear, and a second driven gear coupled to the second arm assembly. The drive unit is coupled to the driving gear and includes an electric motor and a drive unit gearbox. The braking device is configured to inhibit rotation of the first arm assembly and the second arm assembly.

In some implementations, the drive unit gearbox includes one or more planetary gears.

In some implementations, the grabber system includes one or more sensors is configured to sense a characteristic of at least one component of the grabber system.

In some implementations, the grabber system includes a processor coupled to at least one of the sensors configured to apply the braking device in response to information from at least one of the one or more sensors.

In some implementations, the grabber system includes a processor coupled to at least one of the sensors configured to control the drive unit in response to information from at least one of the one or more sensors.

In some implementations, at least one of the sensors is a proximity sensor.

In some implementations, at least one of the sensors is a position sensor.

In some implementations, at least one of the sensors is configured to sense an angle of least one of the components of the grabber drive mechanism.

In a general aspect of the disclosure, a method of loading refuse includes operating a drive unit to close a pair of opposing arms of a grabber system onto a refuse container; receiving information from one or more sensors coupled to the grabber system; and applying, based at least in part on the information from the sensors, a braking device to inhibit movement of the pair of opposing arms.

In some implementations, the method includes operating, based at least in part on the information from the sensors, the drive unit to maintain a hold on refuse container in the grabber system.

In addition to the implementations of the attached claims and the implementations described above, the following numbered example clauses are also within the scope of the present disclosure.

Clause 1 is a system for loading refuse, the system comprising: a refuse loading system configured to empty refuse into a refuse collection vehicle; and a horizontal positioning system configured to couple between the refuse loading system and a frame of the refuse collection vehicle, the horizontal positioning system comprising: a base section configured to couple to the frame of the refuse collection vehicle; an intermediate section coupled to the base section and configured to translate with respect to the base section; a distal section coupled between the intermediate section and the refuse loading system and configured to translate with respect to the intermediate section and the base section; a first timing belt system comprising: a first pair of timing pulleys spaced horizontally from one another and each rotatably coupled to the base section; and a first timing belt coupled in a loop around the first pair of timing pulleys; a second timing belt system comprising: a second pair of timing pulleys spaced horizontally from one another and each rotatably coupled to the intermediate section; and a second timing belt coupled around the second pair of timing pulleys; a first belt attachment device configured to couple the intermediate section to the first timing belt at a first belt attachment location; a second belt attachment device configured to couple the base section to the second timing belt at a second belt attachment location; a third belt attachment device configured to couple the distal section to the second timing belt at a third belt attachment location; and one or more horizontal drive units operable to rotate at least one of the timing pulleys of the first pair of timing pulleys such that the distal section translates horizontally with respect to the base section.

Clause 2 is the system of clause 1, wherein at least one of the one or more horizontal drive units comprise an electric motor.

Clause 3 is the system of clause 1 or 2, wherein at least one of the one or more horizontal drive units comprise an electric motor.

Clause 4 is the system of any one of clauses 1 to 3, wherein at least one of the horizontal drive units is operable to retract the distal section toward the frame of the refuse collection vehicle.

Clause 5 is the system of any one of clauses 1 to 4, wherein the horizontal positioning system further comprises one or more pairs of rail systems coupled between the base section and the distal section.

Clause 6 is the system of clause 5, wherein: at least one of the pairs of rail systems is coupled to the base section such that an offset is defined between a proximal end of a first one of the rail systems and a proximal end of the other one of the rail systems along the extend/retract axis, and at least one of the one or more horizontal drive units is operable to translate the distal section horizontally with respect to the base section along the extend/retract axis.

Clause 7 is the system of clause 6, wherein at least one of the one or more horizontal drive units is at least partially in the offset.

Clause 8 is the system of any one of clauses 5 to 7, wherein: at least one of the one or more horizontal drive units comprises an electric motor; and at least a portion of the electric motor is in the same horizontal plane as least a portion of at least one of the one or more rail systems.

Clause 9 is the system of any one of clauses 5 to 8, wherein at least one of the pairs of rail systems comprises one or more pairs of roller assemblies spaced apart from one another.

Clause 10 is the system of any one of clauses 1 to 9, wherein at least one of the attachment devices comprises an attachment block comprising two or more teeth configured to engage with two or more complementary teeth of one of the timing belts.

Clause 11 is the system of any one of clauses 1 to 10, wherein: the refuse loading system comprises: a grabber system configured to engage a refuse container; and a container lift mechanism coupled between the grabber system and the horizontal positioning system, and the container lift mechanism is operable to lift a refuse container held by the grabber system to empty contents of the refuse container into the refuse collection vehicle.

Clause 12 is the system of clause 11, wherein the container lift mechanism comprises: a mast comprising one or more vertical rails, wherein at least one of the vertical rails comprises one or more guides configured to guide the grabber system on the mast; a timing belt system, comprising: a third pair of timing pulleys spaced vertically from one another and each rotatably coupled to the mast; and a third timing belt coupled around the third pair of timing pulleys; a fourth belt attachment device configured to couple the grabber system to the third timing belt; and one or more vertical drive units configured to rotate at least one of the timing pulleys such that the timing belt pulls the grabber system up the mast.

Clause 13 is the system of clause 12, wherein at least one of the one or more guides comprises arcuate guide portion configured to tip the refuse container as the grabber system is raised to empty contents of the refuse container into a receptacle of the refuse collection vehicle.

Clause 14 is the system of clause 12 or 13, wherein at least one of the vertical drive units comprises an electric motor.

Clause 15 is the system of any one of clauses 1 to 13, wherein the grabber system comprises a grabber system drive unit operable to engage a pair of opposing arms with the refuse container.

Clause 16 is the system of clause 15, wherein the grabber system drive unit comprise an electric motor.

Clause 17 is a horizontal positioning system for a refuse loading system, the horizontal positioning system comprising: a base section configured to couple to a frame of a refuse collection vehicle; a distal section configured to couple between the base section and the refuse loading system and configured to translate with respect to the base section; one or more timing belt systems, at least a first one of the timing belt systems comprising: a pair of timing pulleys spaced horizontally from one another and each rotatably coupled to the base section; and a timing belt coupled around the pair of timing pulleys; one or more belt attachment devices, wherein at least one of the one or more belt attachment devices is configured to couple the base section to the timing belt of at least one of the timing belt systems at a belt attachment location; and one or more horizontal drive units operable to rotate at least one of the timing pulleys such that the distal section translates horizontally with respect to the base section.

Clause 18 is the horizontal positioning system of clause 17, wherein: at least one of the one or more belt attachment devices comprises a pair of attachment blocks, and one of the timing belts is held between the attachment blocks.

Clause 19 is the horizontal positioning system of clause 17 or 18, wherein: at least one of the one or more belt attachment devices comprises a pair of attachment blocks, and one or more of the attachment blocks comprises two or more teeth configured to engage complementary teeth on a timing belt.

Clause 20 is the horizontal positioning system of any one of clauses 17 to 19, wherein at least one of the one or more belt attachment devices comprises two or more fasteners configured to secure a section of one of the timing belts to the belt attachment device.

Clause 21 is the horizontal positioning system of any one of clauses 17 to 20, wherein at least one of the belt attachment devices comprises one or more fasteners configured to pass through the timing belt.

Clause 22 is the horizontal positioning system of any one of clauses 17 to 21, further comprising an intermediate section coupled between the base section and the distal section, wherein the intermediate section is configured to translate relative to the base section and relative to the distal section.

Clause 23 is a method of loading refuse, comprising: rotating a drive pulley engaged with a timing belt to horizontally translate a refuse loading system coupled to a section of the timing belt; and operating the refuse loading system to load refuse into a refuse collection vehicle.

Clause 24 is the method of clause 23, further comprising, before rotating the drive pulley, clamping the section of the timing belt to couple the refuse loading system to the section of the timing belt.

Clause 25 is a system for loading refuse, the system comprising: a refuse loading system configured to load refuse into a refuse collection vehicle; and a horizontal positioning system configured to couple between the refuse loading system and a frame of the refuse collection vehicle, the horizontal positioning system comprising: a base section configured to couple to the frame of refuse collection vehicle; a distal section coupled between the base section and the refuse loading system and configured to translate with respect to the base section; a pair of rail systems coupled between the base section and the distal section, the pair of rail systems configured such that the distal section is translatable relative to the base section along an extend/retract axis, wherein the pair of rail systems is coupled to the base section such that an offset is defined between a proximal end of a first one of the rail systems and a proximal end of the other one of the rail systems along the extend/retract axis, and one or more horizontal drive units operable to translate the distal section horizontally with respect to the base section along the extend/retract axis.

Clause 26 is the system of clause 25, wherein at least one of the horizontal drive units is at least partially in the offset.

Clause 27 is the system of clause 25 or 26, wherein at least one of the one or more horizontal drive units comprises a drive motor; and at least a portion of the drive motor is in the same horizontal plane as least a portion of at least one of the rail systems.

Clause 28 is the system of any one of clauses 25 to 27, further comprising a horizontal drive unit mounting bracket configured to hold at least one of the horizontal drive units and comprising: a first leg comprising an opening through which a drive shaft of the horizontal drive unit passes; and a second leg extending between at least a portion of the horizontal drive unit and a proximal end of at least one of the rail systems.

Clause 29 is the system of any one of clauses 25 to 28, wherein at least one of the rail systems comprises one or more roller assemblies, wherein at least one of the roller assemblies engages on a rail coupled to the base section or a rail coupled to the distal section.

Clause 30 is the system of clause 29, wherein at least one of the roller assemblies comprises an in-line double roller.

Clause 31 is the system of clause 29 or 30, wherein the one or more roller assemblies comprises two or more roller assemblies spaced from one another.

Clause 32 is the system of any one of clauses 25 to 31, wherein at least one of the horizontal drive units comprises a direct drive motor.

Clause 33 is the system of any one of clauses 25 to 32, wherein at least one of the horizontal drive units comprises an electric motor.

Clause 34 is the system of any one of clauses 25 to 33, further comprising: one or more timing belt systems comprising, at least a first one of the timing belt systems comprising: a pair of timing pulleys spaced horizontally from one another and each rotatably coupled to the base section; and a timing belt coupled in a loop around the pair of timing pulleys; and one or more belt attachment devices, wherein at least one of the one or more belt attachment devices is configured to couple the base frame to the timing belt at a belt attachment location, wherein at least one of the horizontal drive units is configured to rotate at least one of the timing pulleys such that the distal section translates horizontally with respect to the base section.

Clause 35 is a system for loading refuse, the system comprising: a refuse loading system configured to empty refuse into a refuse collection vehicle; and a horizontal positioning system configured to couple between the refuse loading system and a frame of the refuse collection vehicle, the horizontal positioning system comprising: a base section configured to couple to a frame of the refuse collection vehicle; an intermediate section coupled to the base section and translatable relative to the base section; a distal section coupled between the intermediate section and the refuse loading system and translatable relative to the intermediate section and the base section; one or more conveyance systems, comprising: a first arcuate support and a second arcuate support, both coupled to the intermediate section; a first flexible tether that engages the first arcuate support and that is fixed to both the base section and the distal section; a second flexible tether that engages the second arcuate support and that is fixed to both the base section and the distal section; and a drive unit configured to drive translation of the intermediate section relative to the base section, the translation of the intermediate section relative to the base section causing movement of the first flexible tether and the second flexible tether that translates the distal section relative to the intermediate section and the base section.

Clause 36 is the system of clause 35, wherein the drive unit comprises an electric motor.

Clause 37 is the system of clause 35 or 36, wherein at least one of the first flexible tether or the second flexible tether comprises a chain.

Clause 38 is the system of any one of clauses 35 to 37, wherein at least one of the first arcuate support or the second arcuate support comprises a sprocket.

Clause 39 is the system of clause 38, wherein: each of the first flexible tether and the second flexible tether comprises a respective timing chain; and each of the first arcuate support and the second arcuate support comprises a respective timing sprocket.

Clause 40 is the system of any one of clauses 35 to 38, wherein at least one of the first flexible tether or the second flexible tether comprises a belt.

Clause 41 is the system of clause 40, wherein at least one of the first arcuate support or the second arcuate support comprises a pulley.

Clause 42 is the system of clause 41, wherein: each of the first flexible tether and the second flexible tether comprises a respective timing belt; and each of the first arcuate support and the second arcuate support comprises a respective timing pulley.

Clause 43 is the system of any one of clauses 35 to 38, wherein at least one of the first flexible tether or the second flexible tether comprises a band.

Clause 44 is the system of any one of clauses 35 to 38, wherein at least one of the first flexible tether or the second flexible tether comprises a cable.

Clause 45 is the system of any one of clauses 35 to 38, wherein at least one of the first flexible tether or the second flexible tether comprises a rope.

Clause 46 is the system of any one of clauses 35 to 45, wherein at least one of the first arcuate support or the second arcuate support comprises a pulley.

Clause 47 is the system of any one of clauses 35 to 46, wherein the first flexible tether and the second flexible tether are of a same type, selected from a group comprising chains, belts, bands, cables, and ropes.

Clause 48 is the system of any one of clauses 35 to 46, wherein the first flexible tether and the second flexible tether are of a different type, selected from a group comprising chains, belts, bands, cables, and ropes.

Clause 49 is the system of any one of clauses 35 to 48, wherein the one or more conveyance systems further comprise: a first attachment device configured to couple the first flexible tether and the second flexible tether to the base section; and a second attachment device configured to couple the first flexible tether and the second flexible tether to the distal section.

Clause 50 is the system of clause 49, wherein: the first flexible tether comprises: a first end portion coupled with the first attachment device; and a second end portion coupled with the second attachment device; and the second flexible tether comprises a third end portion coupled with the first attachment device; and a fourth end portion coupled with the second attachment device.

Clause 51 is the system of any one of clauses 35 to 50, wherein the first flexible tether and the second flexible tether are not in contact with one another.

Clause 52 is the system of any one of clauses 49 to 51, wherein at least one of the first attachment device or the second attachment device is configured to indirectly couple the first flexible tether with the second flexible tether, such that, when a respective end portion of the first flexible tether and a respective end portion of the second flexible tether are attached to the at least one of the first attachment device or the second attachment device, the respective end portion of the first flexible tether and the respective end portion of the second flexible tether extend along a same axis that is parallel to a direction of translation of the intermediate section.

Clause 53 is the system of any one of clauses 49 to 52, wherein at least one of the first attachment device or the second attachment device is configured to indirectly couple the first flexible tether with the second flexible tether, such that, when a respective end portion of the first flexible tether and a respective end portion of the second flexible tether are attached to the at least one of the first attachment device or the second attachment device: the respective end portion of the first flexible tether extends along a first axis that is parallel to a direction of translation of the intermediate section; and the respective end portion of the second flexible tether extends along a second axis, different from the first axis, that is parallel to the direction of translation of the intermediate section.

Clause 54 is the system of any one of clauses 35 to 53, wherein the one or more conveyance systems further comprise a rack and pinion mechanism.

Clause 55 is the system of clause 54, wherein the rack and pinion mechanism comprises: a pinion gear driven by the drive unit, wherein the drive unit is stationary relative to the base section; and a rack comprising teeth that mesh with the pinion gear, wherein the rack is coupled with the intermediate section or integrally formed with the intermediate section.

Clause 56 is a system for loading refuse, the system comprising: a grabber system operable to engage a refuse container; and a container lift mechanism configured to couple between the grabber system and a refuse collection vehicle and operable to lift a refuse container held by the grabber system to empty contents of the refuse container into the refuse collection vehicle, the container lift mechanism comprising: a mast comprising one or more vertical rails, at least one of the vertical rails comprising one or more guides configured to guide the grabber system on the mast; a timing belt system, comprising: a pair of timing pulleys spaced vertically from one another and each rotatably coupled to the mast, the pair of timing pulleys comprising: an upper timing pulley; a lower timing pulley; and a timing belt coupled around the pair of timing pulleys; a belt attachment device configured to couple the grabber system to the timing belt; and one or more vertical drive units configured to rotate at least one of the timing pulleys such that the timing belt pulls the grabber system up the mast.

Clause 57 is the system of clause 56, wherein at least one of the one or more guides comprises an arcuate guide portion configured to tip the refuse container as the grabber system is raised to empty contents of the refuse container into a receptacle of the refuse collection vehicle.

Clause 58 is the system of clause 56 or 57, further comprising one or more roller assemblies, wherein at least one of the one or more roller assemblies comprises one or more rollers configured to roll along at least one of the one or more guides.

Clause 59 is the system of clause 58, wherein at least one of the roller assemblies comprises a pair of in-line rollers configured to sequentially roll along at least a portion of at least one guide.

Clause 60 is the system of clause 58 or 59, wherein at least one of the roller assemblies is configured to move along an arcuate portion of at least one guide such that a refuse container coupled to the grabber system is tipped to empty contents of the refuse container into the refuse collection vehicle.

Clause 61 is the system of any one of clauses 56 to 60, wherein the belt attachment device is configured travel around at least a portion of the upper timing pulley.

Clause 62 is the system of clause 61, wherein the upper timing pulley defines a recess configured to receive at least a portion of the belt attachment device as the attachment device travels around at least a portion of the upper timing pulley.

Clause 63 is the system of clause 62, wherein the recess comprises a gap in a series of teeth in the upper timing pulley.

Clause 64 is the system of clause 61, wherein the timing belt system is configured such that at least a portion of the belt attachment device moves in a path tangential to the upper timing pulley as the belt attachment device travels around the upper timing pulley.

Clause 65 is the system of any one of clauses 56 to 64, wherein the belt system is configured such that at least a portion of the timing belt between the upper timing pulley and the lower timing pulley is non-linear when the grabber system is in a bottom position on the container lift mechanism.

Clause 66 is the system of any one of clauses 56 to 65, wherein at least one of the vertical drive units comprises an electric motor.

Clause 67 is the system of any one of clauses 56 to 66, wherein at least one of the belt attachment devices comprises an attachment block comprising two or more teeth configured to engage with two or more complementary teeth of one of the timing belts.

Clause 68 is the system of any one of clauses 56 to 67, wherein: the belt attachment device comprises a pair of attachment blocks, a first one of the attachment blocks is coupled on the inside of the timing belt; and a second one of the attachment blocks is coupled of the outside of the timing belt.

Clause 69 is the system of any one of clauses 56 to 68, wherein: the belt attachment device comprises a pair of attachment blocks, and at least one of the attachment blocks comprises two or more teeth configured to engage complementary teeth on the timing belt.

Clause 70 is the system of any one of clauses 56 to 69, wherein the belt attachment device comprises two or more fasteners configured to secure a section the timing belt to the belt attachment device.

Clause 71 is the system of any one of clauses 56 to 70, wherein the belt attachment device comprises one or more fasteners configured to pass through the timing belt.

Clause 72 is the system of any one of clauses 56 to 71, wherein at least one of the vertical drive units comprises a direct drive coupled to the upper timing pulley.

Clause 73 is the system of any one of clauses 56 to 72, wherein the grabber system comprises a grabber system drive unit operable to engage a pair of opposing arms with the refuse container.

Clause 74 is the system of clause 73, wherein the grabber system drive unit comprises an electric motor.

Clause 75 is the system of any one of clauses 56 to 74, further comprising one or more debris shields configured to inhibit debris from entering an interior of the timing belt system.

Clause 76 is the system of clause 75, wherein at least one of the debris shields is configured to contact a surface of the timing belt while the timing belt is moving.

Clause 77 is the system of any one of clauses 56 to 76, further comprising one or more scraping members configured to contact an exterior surface of the timing belt and scrape material from the exterior surface.

Clause 78 is the system of clause 77, wherein at least one of the scraping members is on a back-side of the timing belt.

Clause 79 is the system of any one of clauses 56 to 78, further comprising one or more tensioning devices configurable to adjust tension in the timing belt.

Clause 80 is the system of any one of clauses 56 to 79, further comprising one or more idlers configured to contact an exterior surface of the timing belt.

Clause 81 is the system of any one of clauses 56 to 80, wherein at least one of the belt attachment devices comprises an attachment block comprising two or more teeth configured to engage with two or more complementary teeth of one of the timing belts.

Clause 82 is a method of loading refuse, the method comprising: rotating a drive pulley engaged with a timing belt to lift a refuse loading system coupled to a section of the timing belt; and operating the refuse loading system to load refuse into a refuse collection vehicle.

Clause 83 is the method of clause 82, wherein operating the refuse loading system comprises raising a refuse container up a mast of the refuse loading system.

Clause 84 is the method of clause 82 or 83, wherein operating the refuse loading system to load refuse into a refuse collection vehicle comprises lifting a grabber system engaged with a refuse container.

Clause 85 is the method of clause 84, further comprising, before rotating the drive pulley, clamping the section of the timing belt to couple the grabber system to the section of the timing belt.

Clause 86 is the method of any one of clauses 82 to 85, wherein operating the refuse loading system comprises tipping the refuse container such that contents of the refuse container are emptied into a receptacle of the refuse collection vehicle.

Clause 87 is the method of any one of clauses 82 to 86, wherein operating the refuse loading system comprises moving a set of rollers through an arcuate guide such that a refuse container is tipped to empty contents of the refuse container into a refuse collection vehicle.

Clause 88 is the method of any one of clauses 82 to 87, wherein operating the refuse loading system comprises moving a belt attachment device around at least a portion of an upper drive pulley.

Clause 89 is the method of clause 88, further comprising, before rotating the drive pulley, arranging the timing belt to synchronize a position of the belt attachment device relative to a recess in the upper timing pulley.

Clause 90 is the method of any one of clauses 82 to 89, further comprising scraping a surface of the timing belt to inhibit contamination of a timing belt system.

Clause 91 is the method of any one of clauses 82 to 90, wherein rotating the drive pulley engaged with the timing belt comprises operating an electric motor.

Clause 92 is a system for loading refuse, the system comprising: a grabber system operable to engage a refuse container; and a container lift mechanism configured to couple between the grabber system and a refuse collection vehicle and operable to lift a refuse container held by the grabber system to empty contents of the refuse container into the refuse collection vehicle, the container lift mechanism comprising: a mast comprising one or more vertical rails, at least one of the vertical rails comprising one or more guides configured to guide the grabber system on the mast; and one or more vertical drive units configured to raise the grabber system from a bottom position on the mast to a top position on the mast.

Clause 93 is the system of clause 92, wherein at least one of the one or more guides comprises an arcuate guide portion configured to tip the refuse container as the grabber system is raised to empty contents of the refuse container into a receptacle of the refuse collection vehicle.

Clause 94 is the system of clause 92 or 93, further comprising: one or more rotating elements rotatably coupled to mast and vertically spaced from one another on the mast, the one or more rotating elements comprising: an upper rotating element; and a lower rotating element; and a flexible member coupled around the rotating elements, wherein at least one of the vertical drive units is operable to turn at least one of the rotating elements such that a refuse container held by the grabber system is lifted on the mast.

Clause 95 is the system of any one of clauses 92 to 94, wherein at least one of the vertical drive units comprises an electric motor operable to turn an upper rotating element rotatably coupled.

Clause 96 is a system for loading refuse, the system comprising: a grabber system operable to engage a refuse container; and a container lift mechanism operable to lift a refuse container held by the grabber system to empty contents of the refuse container into a refuse collection vehicle, the container lift mechanism comprising: a mast comprising one or more vertical rails; a timing belt system, comprising: a pair of timing pulleys spaced vertically from one another and each rotatably coupled to the mast, the pair of timing pulleys comprising: an upper timing pulley; a lower timing pulley; and a timing belt coupled around the pair of timing pulleys; a belt attachment device configured to couple the grabber system to the timing belt, the belt attachment device configured to travel around at least a portion of the upper timing pulley; and one or more vertical drive units configured to rotate at least one of the timing pulleys such that the timing belt pulls the grabber system up the mast.

Clause 97 is a grabber system for loading refuse, the grabber system comprising: a frame; a first arm assembly pivotally coupled to the frame; a second arm assembly pivotally coupled to the frame; and a grabber drive mechanism coupled to the frame and operable to move the first arm assembly and the second arm assembly between an open position and a closed position to grab a refuse container, the grabber drive mechanism comprising: a driving gear; a first driven gear coupled to the first arm assembly and engaged with the driving gear; a second driven gear coupled to the second arm assembly; an idler gear engaged between the second driven gear and the driving gear; and a drive unit configured to rotate the driving gear.

Clause 98 is the grabber system of clause 97, wherein the drive unit comprises: one or more electric motors; and a gearbox coupled between at least one of the one or more electric motors and the driving gear.

Clause 99 is the grabber system of clause 98, wherein at least a portion of at least one of the one or more electric motors and at least a portion of the gearbox is below the driving gear.

Clause 100 is the grabber system of clause 98, wherein at least a portion of at least one of the one or more electric motors and at least a portion of the gearbox is between the first arm assembly and the second arm assembly.

Clause 101 is the grabber system of any one of clauses 97 to 100, wherein: the driving gear, the first driven gear, and the second driven gear each comprise a rotation axis, and the rotation axes of the driving gear, the first driven gear and the second driven gear are parallel to one another.

Clause 102 is the grabber system of any one of clauses 97 to 101, wherein the drive unit comprises a rotation axis that is parallel to a rotation axis of the driving gear.

Clause 103 is the grabber system of any one of clauses 97 to 102, wherein the drive unit comprises a motor rotation axis that is parallel to a rotation axis of the driving gear.

Clause 104 is the grabber system of any one of clauses 97 to 103, wherein the grabber drive unit rotation axis is coaxial with a rotation axis of the driving gear.

Clause 105 is the grabber system of any one of clauses 97 to 104, wherein the frame comprises: a frame body; and a base extending outwardly from the frame body and configured to receive a bottom pivot element of the first arm assembly and a bottom pivot element of the second arm assembly.

Clause 106 is the grabber system of any one of clauses 97 to 105, wherein the frame comprises: a frame body; a left rail extending upwardly from the frame body and configured to couple with a mast of a container lift mechanism; and a right rail extending upwardly from the frame body and configured to couple with the mast of the container lift mechanism.

Clause 107 is the grabber system of any one of clauses 97 to 106, further comprising a belt-mounting portion configured to couple with a belt of a container lift mechanism.

Clause 108 is the grabber system of any one of clauses 97 to 107, further comprising one or more roller assemblies, wherein at least one of the one or more roller assemblies comprises one or more rollers configured to roll along one or more guides of a container lift mechanism.

Clause 109 is a system for loading refuse, the system comprising: a grabber system, comprising: a frame; a first arm assembly pivotally coupled to the frame; a second arm assembly pivotally coupled to the frame; and a grabber drive mechanism coupled to the frame and operable to move the first arm assembly and the second arm assembly between an open position and a closed position to grab a refuse container, the grabber drive mechanism comprising: a driving gear; a first driven gear coupled to the first arm assembly and engaged with the driving gear; a second driven gear coupled to the second arm assembly; and an idler gear engaged between the second driven gear and the driving gear; and a drive unit configured to rotate the driving gear, the drive unit comprising a motor; and a container lift mechanism configured to configured to couple between the grabber system and a refuse collection vehicle and operable to lift a refuse container held by the grabber system to empty contents of the refuse container into the refuse collection vehicle.

Clause 110 is the system of clause 109, wherein the grabber system further comprises one or more roller assemblies, wherein at least one of the one or more roller assemblies comprises one or more rollers configured to roll along one or more guides of the container lift mechanism.

Clause 111 is the system of clause 109 or 110, wherein the drive unit comprises one or more electric motors.

Clause 112 is the system of any one of clauses 109 to 111, wherein the container lift mechanism comprises one or more electric motors.

Clause 113 is the system of any one of clauses 109 to 112, wherein the container lift mechanism comprises one or more timing belt systems configured to raise the grabber system up a mast of the container lift mechanism.

Clause 114 is the system of any one of clauses 109 to 113, further comprising a horizontal positioning system configured to position the grabber system relative to the refuse collection vehicle.

Clause 115 is the system of clause 114, wherein the horizontal positioning system comprises one or more electric motors.

Clause 116 is the system of any one of clauses 109 to 115, wherein the grabber system further comprises a deflector coupled to the frame and configured to inhibit contents from the refuse container from falling into the system when contents of the refuse container are emptied into the refuse collection vehicle.

Clause 117 is a method of grabbing a refuse container, the method comprising: rotating a driving gear to turn: a first driven gear engaged directly with the driving gear; and a second driven gear engaged with the driving gear by way of an idler gear, such that the first driven gear and the second driven gear each rotate a pair of opposing arms to close the arms on the refuse container; and lifting the refuse container while the refuse container is held between the arms.

Clause 118 is a grabber system for loading refuse, the grabber system comprising: a frame; a first arm assembly pivotally coupled to the frame; a second arm assembly pivotally coupled to the frame; and a grabber drive mechanism coupled to the frame and operable to move the first arm assembly and the second arm assembly between an open position and a closed position to grab a refuse container, the grabber drive mechanism comprising: a grabber gearbox comprising: a driving gear; a first driven gear coupled to the first arm assembly and engaged with the driving gear; a second driven gear coupled to the second arm assembly; and a drive unit coupled to the driving gear and comprising: an electric motor; and a drive unit gearbox, wherein at least portion of the drive unit is below the grabber gearbox.

Clause 119 is the grabber system of clause 118, further comprising a pad coupled to the frame and configured to contact the refuse container between the first arm assembly and the second arm assembly, wherein the drive unit is at least partially behind the pad.

Clause 120 is the grabber system of clause 118 or 119, further comprising an idler gear engaged between the driving gear and one of the driven gears.

Clause 121 is the grabber system of any one of clauses 118 to 120, wherein the grabber gearbox comprises a housing enclosing the driving gear, the first driven gear, and the second driven gear.

Clause 122 is the grabber system of any one of clauses 118 to 121, wherein the grabber gearbox comprises a housing and cover coupled to the housing, and the cover is removable to access at least one of the driving gear, the first driven gear, and the second driven gear.

Clause 123 is a grabber system for loading refuse, the grabber system comprising: a frame; a first arm assembly pivotally coupled to the frame; a second arm assembly pivotally coupled to the frame; and a grabber drive mechanism coupled to the frame and operable to move the first arm assembly and the second arm assembly between an open position and a closed position to grab a refuse container, the grabber drive mechanism comprising: a grabber gearbox comprising: a driving gear; a first driven gear coupled to the first arm assembly and engaged with the driving gear; a second driven gear coupled to the second arm assembly; and a drive unit coupled to the driving gear and comprising: an electric motor; and a drive unit gearbox; and a braking device configured to inhibit rotation of the first arm assembly and the second arm assembly.

Clause 124 is the grabber system of clause 123, wherein the drive unit gearbox comprises one or more planetary gears.

Clause 125 is the grabber system of clause 123 or 124, further comprising one or more sensors configured to sense a characteristic of at least one component of the grabber system.

Clause 126 is the grabber system of clause 125, further comprising a processor coupled to at least one of the sensors configured to apply the braking device in response to information from at least one of the one or more sensors.

Clause 127 is the grabber system of clause 125, further comprising a processor coupled to at least one of the sensors configured to control the drive unit in response to information from at least one of the one or more sensors.

Clause 128 is the grabber system of any one of clauses 125 to 127, wherein at least one of the sensors is a proximity sensor.

Clause 129 is the grabber system of any one of clauses 125 to 128, wherein at least one of the sensors is a position sensor.

Clause 130 is the grabber system of any one of clauses 125 to 129, wherein at least one of the sensors is configured to sense an angle of least one of the components of the grabber drive mechanism.

Clause 131 is a method of loading refuse, the method comprising: operating a drive unit to close a pair of opposing arms of a grabber system onto a refuse container; receiving information from one or more sensors coupled to the grabber system; and applying, based at least in part on the information from the sensors, a braking device to inhibit movement of the pair of opposing arms.

Clause 132 is the method of clause 131, further comprising operating, based at least in part on the information from the sensors, the drive unit to maintain a hold on refuse container in the grabber system.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

1. A system for loading refuse, the system comprising:
a refuse loading system configured to empty refuse into a refuse collection vehicle; and
a horizontal positioning system configured to couple between the refuse loading system and a frame of the refuse collection vehicle, the horizontal positioning system comprising:
a base section configured to couple to the frame of the refuse collection vehicle;
an intermediate section coupled to the base section and configured to translate with respect to the base section;
a distal section coupled between the intermediate section and the refuse loading system and configured to translate with respect to the intermediate section and the base section;
a first timing belt system comprising:
a first pair of timing pulleys spaced horizontally from one another and each rotatably coupled to the base section; and
a first timing belt coupled in a loop around the first pair of timing pulleys;
a second timing belt system comprising:
a second pair of timing pulleys spaced horizontally from one another and each rotatably coupled to the intermediate section; and
a second timing belt coupled around the second pair of timing pulleys;
a first belt attachment device configured to couple the intermediate section to the first timing belt at a first belt attachment location;
a second belt attachment device configured to couple the base section to the second timing belt at a second belt attachment location;
a third belt attachment device configured to couple the distal section to the second timing belt at a third belt attachment location; and
one or more horizontal drive units operable to rotate at least one of the timing pulleys of the first pair of timing pulleys such that the distal section translates horizontally with respect to the base section.

2. The system of claim 1, wherein at least one of the one or more horizontal drive units comprises an electric motor.

3. The system of claim 1, wherein at least one of the horizontal drive units is operable to extend the distal section away from the frame of the refuse collection vehicle.

4. The system of claim 1, wherein at least one of the horizontal drive units is operable to retract the distal section toward the frame of the refuse collection vehicle.

5. The system of claim 1, wherein the horizontal positioning system further comprises one or more pairs of rail systems coupled between the base section and the distal section.

6. The system of claim 5, wherein:
at least one of the pairs of rail systems is coupled to the base section such that an offset is defined between a proximal end of a first one of the rail systems and a proximal end of the other one of the rail systems along the extend/retract axis, and
at least one of the one or more horizontal drive units is operable to translate the distal section horizontally with respect to the base section along the extend/retract axis.

7. The system of claim 6, wherein at least one of the one or more horizontal drive units is at least partially in the offset.

8. The system of claim 5, wherein:
at least one of the one or more horizontal drive units comprises an electric motor; and
at least a portion of the electric motor is in the same horizontal plane as least a portion of at least one of the one or more rail systems.

9. The system of claim 5, wherein at least one of the pairs of rail systems comprises one or more pairs of roller assemblies spaced apart from one another.

10. The system of claim 1, wherein at least one of the attachment devices comprises an attachment block comprising two or more teeth configured to engage with two or more complementary teeth of one of the timing belts.

11. The system of claim 1, wherein:
the refuse loading system comprises:
a grabber system configured to engage a refuse container; and
a container lift mechanism coupled between the grabber system and the horizontal positioning system, and
the container lift mechanism is operable to lift a refuse container held by the grabber system to empty contents of the refuse container into the refuse collection vehicle.

12. The system of claim 11, wherein the container lift mechanism comprises:
a mast comprising one or more vertical rails, wherein at least one of the vertical rails comprises one or more guides configured to guide the grabber system on the mast;
a timing belt system, comprising:
a third pair of timing pulleys spaced vertically from one another and each rotatably coupled to the mast; and
a third timing belt coupled around the third pair of timing pulleys;
a fourth belt attachment device configured to couple the grabber system to the third timing belt; and
one or more vertical drive units configured to rotate at least one of the timing pulleys such that the timing belt pulls the grabber system up the mast.

13. The system of claim 12, wherein at least one of the one or more guides comprises arcuate guide portion configured to tip the refuse container as the grabber system is raised to empty contents of the refuse container into a receptacle of the refuse collection vehicle.

14. The system of claim 12, wherein at least one of the vertical drive units comprises an electric motor.

15. The system of claim 1, wherein the grabber system comprises a grabber system drive unit operable to engage a pair of opposing arms with the refuse container.

16. The system of claim 15, wherein the grabber system drive unit comprises an electric motor.

17. A horizontal positioning system for a refuse loading system, the horizontal positioning system comprising:
a base section configured to couple to a frame of a refuse collection vehicle;
a distal section configured to couple between the base section and the refuse loading system and configured to translate with respect to the base section;
one or more timing belt systems, at least a first one of the timing belt systems comprising:
a pair of timing pulleys spaced horizontally from one another and each rotatably coupled to the base section; and
a timing belt coupled around the pair of timing pulleys;
one or more belt attachment devices, wherein at least one of the one or more belt attachment devices is configured to couple the base section to the timing belt of at least one of the timing belt systems at a belt attachment location; and
one or more horizontal drive units operable to rotate at least one of the timing pulleys such that the distal section translates horizontally with respect to the base section.

18. The horizontal positioning system of claim 17, wherein:
at least one of the one or more belt attachment devices comprises a pair of attachment blocks, and
one of the timing belts is held between the attachment blocks.

19. The horizontal positioning system of claim 17, wherein:
at least one of the one or more belt attachment devices comprises a pair of attachment blocks, and
one or more of the attachment blocks comprises two or more teeth configured to engage complementary teeth on a timing belt.

20. The horizontal positioning system of claim 17, wherein at least one of the one or more belt attachment devices comprises two or more fasteners configured to secure a section of one of the timing belts to the belt attachment device.

21. The horizontal positioning system of claim 17, wherein at least one of the belt attachment devices comprises one or more fasteners configured to pass through the timing belt.

22. The horizontal positioning system of claim 17, further comprising an intermediate section coupled between the base section and the distal section, wherein the intermediate section is configured to translate relative to the base section and relative to the distal section.

23. A method of loading refuse, the method comprising:
rotating a drive pulley engaged with a timing belt to horizontally translate a refuse loading system coupled to a section of the timing belt; and
operating the refuse loading system to load refuse into a refuse collection vehicle.

24. The method of claim 23, further comprising, before rotating the drive pulley, clamping the section of the timing belt to couple the refuse loading system to the section of the timing belt.

25. A system for loading refuse, the system comprising:
a refuse loading system configured to load refuse into a refuse collection vehicle; and
a horizontal positioning system configured to couple between the refuse loading system and a frame of the refuse collection vehicle, the horizontal positioning system comprising:
a base section configured to couple to the frame of refuse collection vehicle;
a distal section coupled between the base section and the refuse loading system and configured to translate with respect to the base section;
a pair of rail systems coupled between the base section and the distal section, the pair of rail systems configured such that the distal section is translatable relative to the base section along an extend/retract axis, wherein the pair of rail systems is coupled to the base section such that an offset is defined between a proximal end of a first one of the rail systems and a proximal end of the other one of the rail systems along the extend/retract axis; and
one or more horizontal drive units operable to translate the distal section horizontally with respect to the base section along the extend/retract axis.

26. The system of claim 25, wherein at least one of the horizontal drive units is at least partially in the offset.

27. The system of claim 25, wherein at least one of the one or more horizontal drive units comprises a drive motor; and at least a portion of the drive motor is in the same horizontal plane as least a portion of at least one of the rail systems.

28. The system of claim 25, further comprising a horizontal drive unit mounting bracket configured to hold at least one of the horizontal drive units and comprising:
a first leg comprising an opening through which a drive shaft of the horizontal drive unit passes; and
a second leg extending between at least a portion of the horizontal drive unit and a proximal end of at least one of the rail systems.

29. The system of claim 25, wherein at least one of the rail systems comprises one or more roller assemblies, wherein at least one of the roller assemblies engages on a rail coupled to the base section or a rail coupled to the distal section.

30. The system of claim 29, wherein at least one of the roller assemblies comprises an in-line double roller.

31. The system of claim 29, wherein the one or more roller assemblies comprises two or more roller assemblies spaced from one another.

32. The system of claim 25, wherein at least one of the horizontal drive units comprises a direct drive motor.

33. The system of claim 25, wherein at least one of the horizontal drive units comprises an electric motor.

34. The system of claim 25, further comprising:
one or more timing belt systems comprising, at least a first one of the timing belt systems comprising:
a pair of timing pulleys spaced horizontally from one another and each rotatably coupled to the base section; and
a timing belt coupled in a loop around the pair of timing pulleys; and
one or more belt attachment devices, wherein at least one of the one or more belt attachment devices is configured to couple the base frame to the timing belt at a belt attachment location,
wherein at least one of the horizontal drive units is configured to rotate at least one of the timing pulleys such that the distal section translates horizontally with respect to the base section.
